(19) United States
(12) Patent Application Publication
(10) Pub. No.: US 2008/0068293 A1
(43) Pub. Date: Mar. 20, 2008

(54) Display Uniformity Correction Method and System

(75) Inventor: Takatoshi Ishii, Sunnyvale, CA (US)

Correspondence Address: STRATEGIC PATENT GROUP, P.C., P.O. BOX 1329, MOUNTAIN VIEW, CA, 94042, US

(73) Assignee: TVIA, Inc., Santa Clara, CA (US)

(21) Appl. No.: 11/533,277

(22) Filed: Sep. 19, 2006

(51) Int. Cl. G09G 5/00

(52) U.S. Cl. 345/3.1

(57) ABSTRACT

A method and system are provided for correcting non-uniformity of a display device having a display screen comprising a pixel matrix. Aspects the exemplary embodiment include in response to receiving display data for display, reading from a memory of the display device compensation data stored for a subset of pixel locations on the display screen, the compensation data configured to correct non-uniformity characteristics of the display screen; interpolating the compensation data to generate uniformity correction data; overlaying the display data with the uniformity correction data to produce uniformity corrected display data; and outputting the uniformity corrected display data for subsequent display.

### CROSS-REFERENCED TO RELATED APPLICATIONS

The present application is related to co-pending patent application U.S. application Ser. No. ______ entitled “Gamma Uniformity Correction Method and System”, and U.S. application Ser. No. ______ entitled “Frame Rate Control Method and System”, filed on the same date as the present application and assigned to the same assignee.

### BACKGROUND OF THE INVENTION

Flat panel displays are becoming the display of choice for laptop, desktop, and handheld computers alike. There use in televisions is also growing. Flat-panel type displays can take a variety of forms, the most common of which is the liquid crystal type display. Other types include light emitting diode (LED) displays and plasma displays. Liquid crystal displays (LCD) include an active matrix type, which are also called TFT (Thin Film Transistor) type, and a passive matrix type, which are also called STN (Super Twisted Nematic) type. Both of these are available in monochromatic or color versions. STN types of flat panel display comprise an array of pixels that can individually be commanded to switch towards only one of two brightness levels, on or off (i.e. white or black), while a TFT can have 256 shades of red, green, and blue (RGB). Such flat panel displays are driven by a controller which is typically a portion of an integrated circuit chip and is also referred to as a display controller or an LCD controller.

The size of flat-panel displays is a consumer TV market trend that continues to increase, growing in recent years from 20″ to 32″ or 40″ to 50″. As the size of flat-panel displays continues to rise, so does the required size of a backlight and the resolution of flat-panel displays e.g., from 640×480 to 1280×768 to 1920×1080 and so on. As the size of a flat panel becomes larger, it becomes increasingly difficult to maintain the same characteristics of flat-panel uniformly over the screen. Characteristics of the flat panel that may become non-uniform include brightness in the form of bias shift and gain error, and black levels. The magnitude of the non-uniformities appearing in larger displays may also increase the likelihood that new display devices or early stage product of the existing display devices will create yield issues for manufacturers during production.

Accordingly, what is needed is an improved scheme that compensates for the non-uniformities in display characteristics of display devices including flat-panel LCD displays.

### BRIEF SUMMARY OF THE INVENTION

The present invention provides a method and system for correcting non-uniformity of a display device having a display screen comprising a pixel matrix. Aspects the exemplary embodiment include in response to receiving display data for display, reading from a memory of the display device compensation data stored for a subset of pixel locations on the display screen, the compensation data configured to correct non-uniformity characteristics of the display screen; interpolating the compensation data to generate uniformity correction data; overlaying the display data with the uniformity correction data to produce uniformity corrected display data; and outputting the uniformity corrected display data for subsequent display.

According to the method and system disclosed herein, the exemplary embodiment improves overall image quality of the display device by providing uniformity corrected display data that compensates for the non-uniformities in the display characteristics of the display device, even as the size of display devices becomes larger. Consequently, the exemplary embodiment may also increase production yields of display devices for manufacturers.

### BRIEF DESCRIPTION OF SEVERAL VIEWS OF THE DRAWINGS

FIG. 1 is a block diagram illustrating a display device for use in accordance with an exemplary embodiment.

FIG. 2A is a graph showing bias shift phenomena that may occur in a display device.

FIG. 2B is a graph showing gain error of display device pixels.

FIG. 3 is a flow diagram illustrating a method for correcting non-uniformity of a display device.

FIG. 4 is a diagram illustrating the display screen divided into a pixel grid according to one exemplary embodiment.

FIG. 5 is a block diagram illustrating components of the pixel process pipeline.

FIGS. 6A and 6B are block diagrams illustrating components of the display uniformity controller to an exemplary embodiment.

FIG. 7 is a diagram graphically illustrating a bit overlay arrangement used by the DUC to generate the 12-bit uniformity corrected display data.

FIG. 8A is a block diagram showing components of the gain uniformity correction (GUC) generator.

FIG. 8B is a graph showing gain compensation in the display device pixels in accordance with the exemplary embodiment.

FIG. 9 is a diagram showing the gain compensation data stored as a pixel grid in the data memory of the GUC and interpolation operations for current pixel P (X, Y).

FIG. 10 is a diagram illustrating bit arrangement of the GUC generator internal data bus bit alignment of variables used for generating the gain uniformity corrected data according to an exemplary embodiment.

FIG. 11A is a block diagram showing components of the bias uniformity correction (BUC) generator.

FIG. 11B is a graph showing bias compensation in the display device pixels in accordance with the exemplary embodiment.

FIG. 12 is a diagram showing the bias compensation data stored as a pixel grid in the data memory of the BUC and interpolation operations for current pixel P (X, Y).

FIG. 13 is a diagram illustrating bit arrangement of the BUC generator internal data bus bit alignment of variables used for generating the bias uniformity corrected data according to an exemplary embodiment.

FIG. 14A is a block diagram showing components of the black level uniformity correction (GUC) generator.

FIG. 14B is a graph showing black level leakage correction of the display device pixels in accordance with the exemplary embodiment.

FIG. 15 is a diagram showing the black-level compensation data stored as a pixel grid in the data memory of the BLC and interpolation operations for current pixel P (X, Y).

FIG. 16 is a diagram illustrating bit arrangement of the BLC generator internal data bus bit alignment of variables used for generating the bias uniformity correction data 610c according to an exemplary embodiment.

FIG. 17A is a block diagram illustrating components of the gamma lookup table (GLUT).

FIG. 17B is a graph illustrating an example of gamma correction that may occur in the display device.

FIG. 17C is a diagram illustrating bit positions of the 10-bit display data that is input to the GLUT.

FIG. 18 is a diagram illustrating bit arrangement of MSB data multiplexer internal data bus bit alignment in accordance with an exemplary embodiment.

FIG. 19 is a diagram illustrating bit arrangement of the GLUT internal data bus bit alignment of variables used for generating the gamma corrected display data according to an exemplary embodiment.

FIG. 20 is a block diagram of the frame rate controller of FIG. 5.

FIG. 21A shows an exemplary pattern stored in the pixel sequence LUT.

FIG. 21B is a diagram showing by way of an example, the interrelationship between the flat-panel display and a dither pattern.

FIG. 21C is a diagram illustrating sequence number population of the sequence number pattern.

FIG. 22 shows 16 frames that may be used to create a constant energy display in any 4×4 area in a frame where Din_f=3.

FIG. 23 shows a table used by the comparator to compare the output of a multiplier with a sequence number generated from the pixel sequence lookup table.

### DETAILED DESCRIPTION OF THE INVENTION

The present invention relates to display uniformity correction. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The embodiments disclosed herein are mainly described in terms of particular device and system provided in particular implementations. However, one of ordinary skill in the art will readily recognize that this method and system will operate effectively in other implementations. For example, the circuits and devices usable with the present invention can take a number of different forms. The present invention will also be described in the context of particular methods having certain steps. However, the method and system operate effectively for other methods having different and/or additional steps not inconsistent with the present invention.

According to the exemplary embodiment, a method and system for display uniformity correction is provided. The display uniformity correction may include measuring non-uniformity characteristics, such as bias, gain, and backlight leakage, of a flat-panel display screen. Thereafter, compensation data configured to correct the non-uniformity characteristics is created. The compensation data may be considered a complement to the non-uniformity data. The compensation data is stored in a small memory in the flat-panel, and is preferably compressed by storing the compensation data for only a subset of the pixels comprising the flat-panel. As display data is received and the flat-panel is scanned to display an image, the compensation data is decompressed by reading only the compensation data surrounding a current pixel location from the memory, and then performing real-time interpolation on the compensation data to generate correction data for the current pixel. The interpolated correction data is then overlaid and superimposed on the display data to create uniformity corrected display data. The uniformity corrected display data is then displayed on the display screen, thereby providing improved image quality.

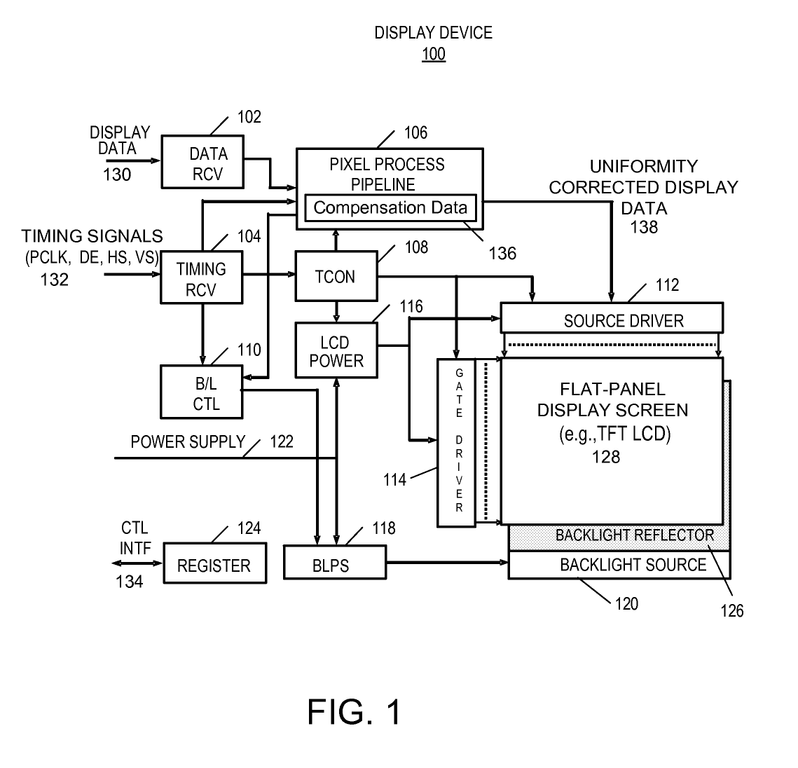

FIG. 1 is a block diagram illustrating a display device for use in accordance with an exemplary embodiment. The display device 100 includes components necessary for receiving, processing, and displaying display data 130 on a monochromatic or color flat-panel display screen 128 (hereinafter referred to as display screen 128). Although the display screen 128 is shown as a thin-film transistor (TFT) liquid crystal display (LCD), the display device 100 may include other types of flat-panel displays, such as a super twisted nematic (STN) LCD. In addition, the exemplary embodiment is not intended to be limited to any one display technology, and should be applicable to all types of displays where pixels are discreetly commanded towards one of a bright or dark level.

Conventional components of the display device 100 for producing a picture on the display screen 128 include a data receive block 102, a timing receive block 104, a timing control (TCON) block 108, a backlight control (B/L CTL) block 110, a source driver 112, a gate driver 114, a LCD power control 116, a backlight power supply inverter (BLPS) 118, a backlight source 120, a backlight reflector 126, and a register block 124. In accordance with the exemplary embodiment, the display device 100 is further provided with a pixel process pipeline 106 that enhances the incoming display data 130 to improve display picture quality, as explained further below.

In one embodiment, the display screen 128 is capable of displaying display data at 8-bit resolution, meaning that 256 shades of grayscaling can be displayed. As those with ordinary skill in the art will readily understand, the term “grayscale” may apply not only to monochromatic displays but also to color displays where the brightness or perceived luminance of a colored region is to vary across a pre-determined intensity range.

The data receive block 102 receives the input display data 130, which in one embodiment comprises frames of RGB (Red, Green, Blue) digital pixel data having 10-bits for each RGB component, and outputs the display data 130 to the pixel process pipeline 106. The timing receive block 104 receives timing signals 132 from a display controller (not shown) and outputs the timing signals to the timing control block (TCON) 108, the backlight control block 110, and the pixel process pipeline 106. The timing signals 132 may include a pixel clock (PCLK) signal, a display enable (DE) bit, a horizontal sync (HS) signal, and a vertical sync (VS) signal. The timing control block (TCON) 108 generates further internal timing control signals for the pixel process pipeline 106, the source driver 112, the gate driver 114, and the LCD power control 116.

The LCD power control 116 may include a DC-to-DC converter and generates relatively high voltage for the source driver 112 and gate driver 114. The backlight control block 110 generates backlight control signals, which are output to the backlight power supply inverter 118. The backlight power supply inverter 118 generates high voltage for backlight lighting, which is supplied to the backlight source 120 and backlight reflector 126. The backlight reflector 126, in turn, distributes the light from the backlight source 120 as evenly as possible. The value of the high voltage depends on the type backlight source 120, e.g., CCFL (Cold Cathode Fluorescent Lamps) or LED (Light Emitted Diode). Necessary electric power is supplied by a power supply line 122 from a host computer system (not shown). The LCD power control 116 and the backlight power supply inverter 118 convert the voltage from the power supply line 122 to meet the requirements of the source driver 112, gate driver 114, and the backlight source 120. All necessary parameters for the above operations are given from a register value in the register block 124, which are written and read through a control interface (CTL INTF) signal by system software or one of peripherals from a computer system (not shown).

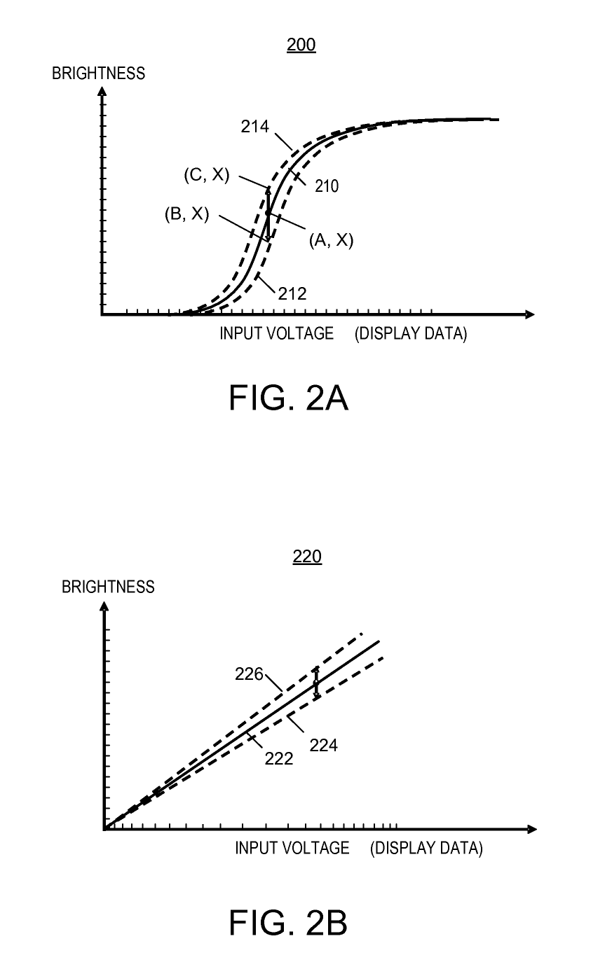

As explained above, characteristics of the display screen 128 that may cause non-uniformity include variations in brightness (bias shift and gain error) and black levels. Bias shift, gain error and black level leakage are non-uniformity characteristics that may occur in the display screen 128 and are briefly explained with respect to FIGS. 2A and 2B.

FIG. 2A is a graph 200 showing bias shift phenomena that may occur in a display device. The values for brightness are shown along the Y-axis of the graph 200, and input voltage values are shown along the X-axis. The display screen 128 operates with varying input voltages, which is a value converted from the display data 130 by the source driver 112. As the input voltage is increased, the brightness of the display screen 128 is increased. Different pixel locations of the display screen 128 will react differently to the same input voltage due to various variables, such as temperature, dust, and production process parameters, which will vary characteristics of the display screen 128, resulting in bias response curves that vary from normal. For example, a particular input voltage will produce an average/normal brightness value, at pixel (A, X), along a normal bias response curve 210. But some pixel locations may appear darker at the same input voltage, as shown by point (B, X) on bias response curve 212, or brighter, as shown by point (C, X) on bias response curve 214.

FIG. 2B is a graph 220 showing gain error of display device pixels. The values for brightness are shown along the Y-axis of the graph 220, and the input voltage values are shown along the X-axis. As above, different pixel locations of the display screen 128 will react differently to the same input voltage, resulting in various gain curves. For example, a particular input voltage will produce an average brightness value along a normal gain curve 222, but produce darker locations at the same input voltage, as shown by curve 224, or produce brighter locations, as shown by curve 226.

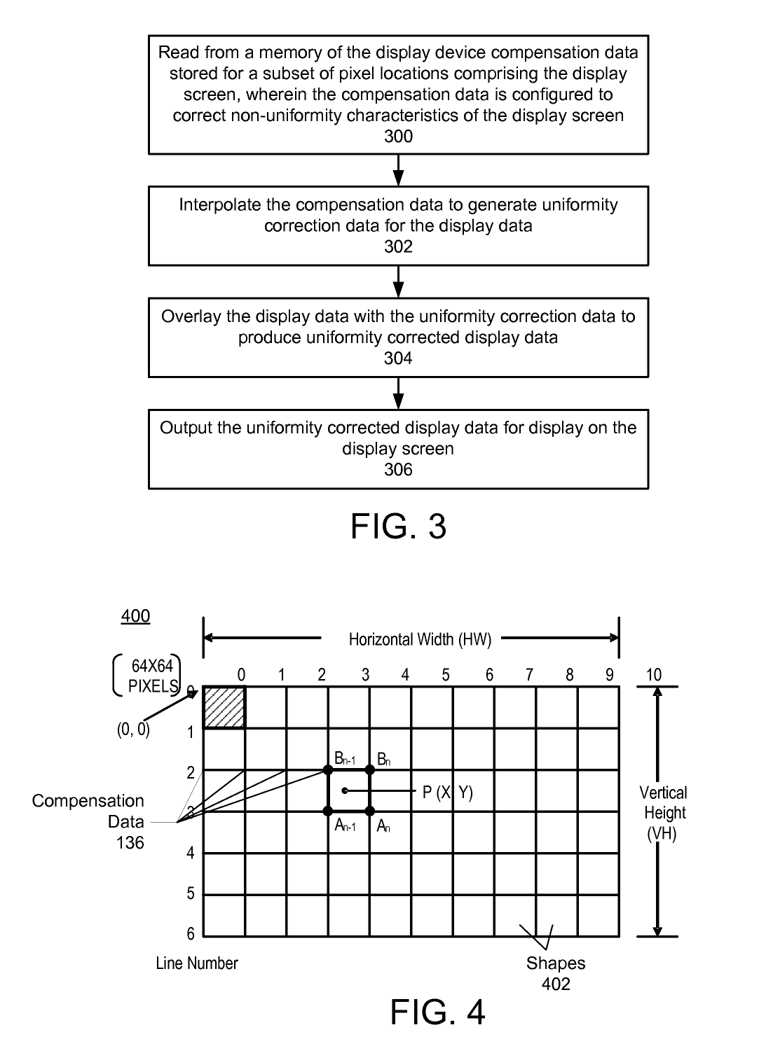

In accordance with the exemplary embodiment, the pixel process pipeline 106 shown in FIG. 1 effectively corrects such non-uniformity characteristics of the display screen 128, as described with reference to FIG. 3.

FIG. 3 is a flow diagram illustrating a method for correcting non-uniformity of the display device. Referring to both FIGS. 1 and 3, the process begins in step 300 wherein in response to receiving display data 130 for display, the pixel process pipeline 106 reads from a memory of the display device 100 compensation data 136 stored for a subset (i.e., less than the total number) of the pixel locations comprising the display screen 128, wherein the compensation data 136 is configured to correct the non-uniformity characteristics of the display screen 128.

According to one embodiment, the compensation data 136 is created and stored during a configuration stage, which could occur for example, during manufacturing/testing of the display device 100 and/or the display screen 128. During the configuration stage, non-uniformity characteristics of the display screen 128 are measured using well-known methods, and compensation data for correcting the non-uniformity characteristics is determined. The compensation data 136 is compressed to reduce storage space requirements by storing the compensation data 136 only for a subset of pixel locations comprising the display screen 128 in one or more memories (described below) of the display device 100. According to one aspect of the exemplary embodiment, the subset of pixel locations is defined by dividing the display screen into a pixel grid and storing the compensation data 136 only for points comprising the pixel grid, as shown in FIG. 4.

FIG. 4 is a diagram illustrating the display screen 128 divided into a pixel grid 400 according to one exemplary embodiment. The pixel matrix of the display screen 128 is divided into a pixel grid 400 of horizontal rows and vertical columns and intersections of these lines make grid points. The number of columns is given by a horizontal width (HW) of the display screen 128, and the number of rows is given by the vertical height (VH). The screen origin (0, 0) may be assigned Rs, Gs, and Bs starting data. The resolution of the display screen 128 is specified by a screen width (SW) and a screen height (SH) (not shown). The horizontal width (HW) of the pixel grid 400 should be less than the screen width (SW) and the vertical height (VH) of the pixel grid 400 should be less than the screen height (SH).

Adjacent points at row and column intersections of the pixel grid 400 are used to define a matrix of shapes 402 across the display screen 128 that encompass multiple pixels of the display screen 128. In an exemplary embodiment, the shapes 402 defined by the points at the row and column intersections are blocks, which are bounded by four grid points. For example, pixel P at location (X, Y) of the display screen 128 falls within a block defined by the four points labeled An, An−1, Bn, and Bn−1. In alternative embodiments, the points may be selected to define shapes 402 other than blocks, such as rectangles, circles, and polygons for example. In each example, each type of shape 402 should encompass multiple rows and columns of pixels.

According to the exemplary embodiment, the compensation data 136 is compressed to reduce storage space requirements by storing the compensation data 136 only for the grid points of the pixel grid 400 that define shapes 402. In one embodiment, values for the compensation data 136 may be stored specifically for each grid point (e.g., Bn, Bn−1, Bn−2, . . . , An−n; An, An−1, An−2, . . . , An−n). However, in a preferred embodiment, only the differences between compensation data 136 values between adjacent grid points are stored for each grid point. These difference values may also be referred to as differential values.

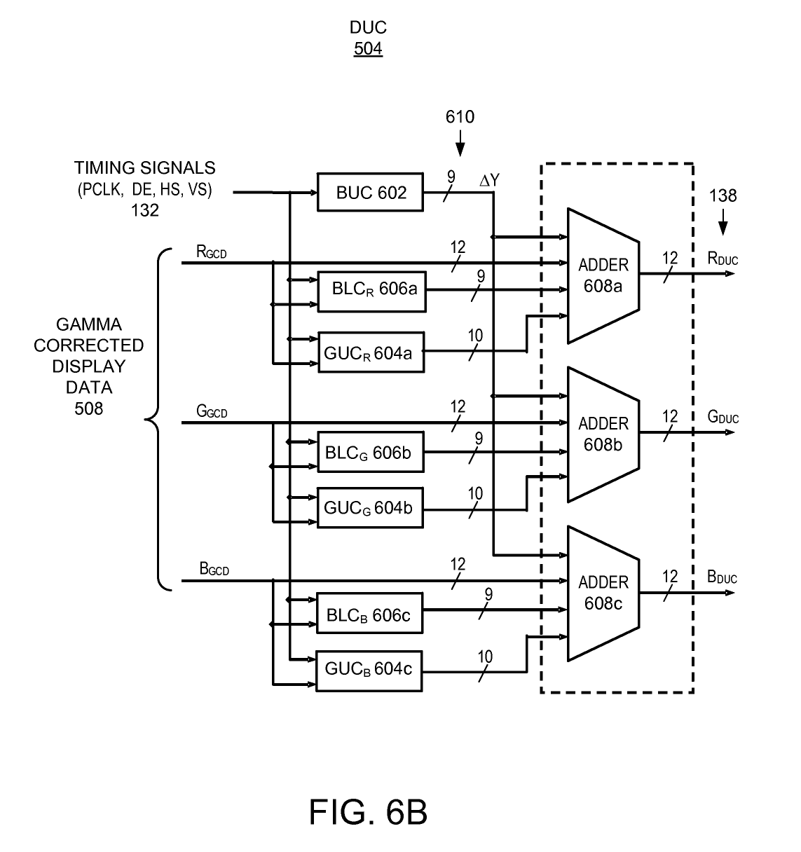

Referring again to FIG. 3, as the display data 130 is received and the display screen 128 is scanned to display an image, in step 302, the pixel process pipeline 106 interpolates the compensation data 136 to generate uniformity correction data for the display data 130. More specifically, referring to FIGS. 1 and 4, in response to receiving a current pixel location from the display data 130 as indicated by the timing signals 132, e.g., P (X,Y), the pixel process pipeline 106 reads the compensation data 136 corresponding to the shape 602 encompassing the current pixel location, e.g., compensation data for points An, An−1, Bn, and Bn−1, and interpolates this compensation data 136 to generate uniformity correction data 610 (FIG. 6A) for the current pixel location. Thus, through interpolation of the compressed compensation data 136, uniformity correction data 610 can be generated for all of the pixels of the display screen 120, even for pixels that have no stored compensation data 136, thereby reducing memory requirements.

In step 304, the pixel process pipeline 106 overlays the display data 130 with the uniformity correction data 610 to produce uniformity corrected display data 138. Finally, in step 306, the pixel process pipeline 106 outputs the uniformity corrected display data 138 for display on the display screen 128.

According to the method and system of the exemplary embodiment, providing uniformity corrected display data 138 that compensates for the non-uniformities in the display characteristics of the display device effectively improves overall image quality of the display device, even with increasing sizes of display devices. Consequently, the exemplary embodiment may also increase production yields of display devices for manufacturers.

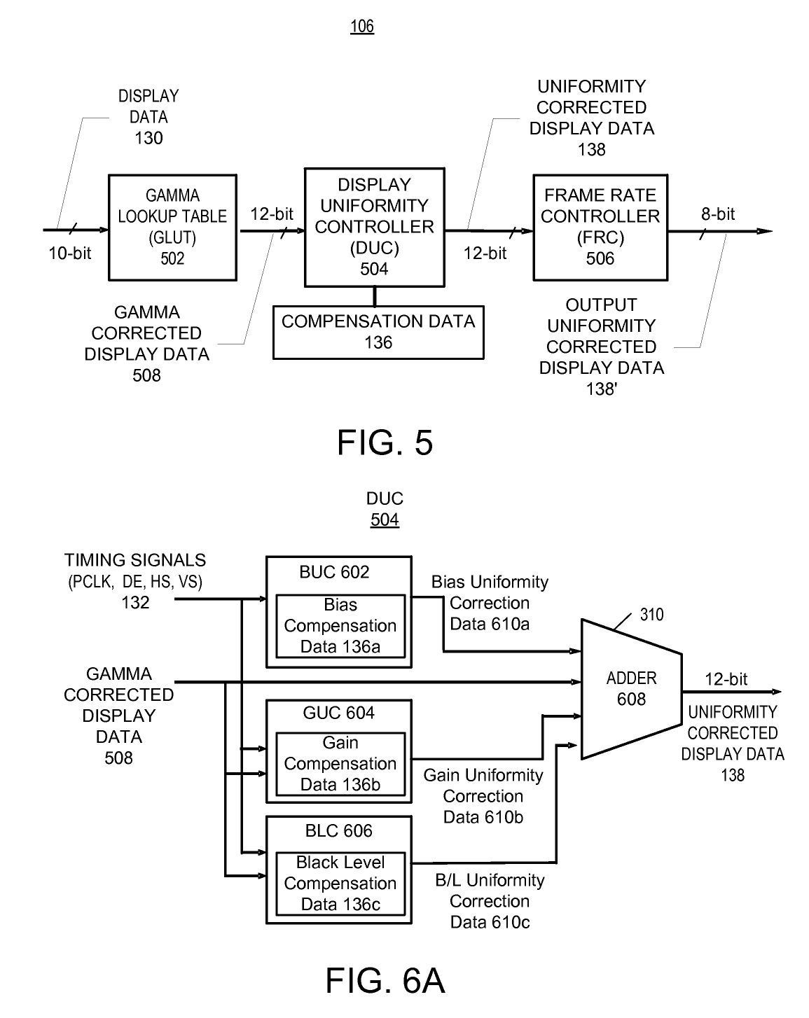

FIG. 5 is a block diagram illustrating components of the pixel process pipeline 106. In one exemplary embodiment, the pixel process pipeline 106 may include a gamma lookup table (GLUT) block 502, a display uniformity controller (DUC) 504 coupled to the GLUT block 502, and a frame rate controller (FRC) 506 coupled to the display uniformity controller 504.

The GLUT block 502 performs gamma correction on the RGB display data 130 to control the overall brightness of the image and outputs gamma corrected display data 508. The GLUT block 502 may be optionally configured to perform white balance control also. Although gamma correction of RGB the display data 130 provided by the GLUT block 502 is shown as a part of the pixel process pipeline 106, gamma correction functions and/or functions of the FRC 506 are optional and may be performed outside the pixel process pipeline 106.

As described above, the display uniformity controller 504 increases uniformity of the display screen 128 by applying and overlaying compensation data 136 on to the display data. More specifically, the display uniformity controller 504 interpolates the compensation data 136 to generate uniformity correction data 610 (shown in FIGS. 6A and 6B), and overlays the uniformity correction data 610 with the gamma corrected display data 508 to generate the uniformity corrected display data 138 that compensates for the non-uniformity characteristics of the display screen 128. In the exemplary embodiment, the display uniformity controller 504 and the compensation data 136 are configured to perform a combination of gain uniformity correction, black level correction, and bias uniformity correction. In alternative embodiments, the display uniformity controller 504 may be configured to perform more or less types of uniformity corrections.

According to the exemplary embodiment, the data width of display data 130 input to, and output from, inside modules of the pixel process pipeline 106 may be changed by data processing. For example, the GLUT block 502 may increase the data width of the incoming display data 130 so that the display uniformity controller 504 may perform more precise display uniformity correction. In the embodiment shown, the display data 130 is input to the GLUT 502 as 8 or 10-bit RGB, but the GLUT block 502 outputs the gamma corrected display data 508 as 12-bit RGB. The display uniformity controller 504 also outputs the uniformity corrected display data 138 as 12-bit RGB. Thereafter, the FRC 506 is used to reduce the data width of the uniformity corrected display data 138 to match the data width of the source driver 112 prior to display. In one embodiment, the FRC 506 uses a static dither or dynamic dither algorithm and converts the 12-bit uniformity corrected display data 138 to 8-bit output uniformity corrected display data 138′ for display.

FIGS. 6A and 6B are block diagrams illustrating components of the display uniformity controller 504 according to an exemplary embodiment. For simplicity, FIG. 6A illustrates the components of the display uniformity controller 504 for processing one color component, while FIG. 6B illustrates the components of the display uniformity controller 504 for processing each RGB color component.

Referring to FIG. 6A, the display uniformity controller (DUC) 504 may include means for generating bias uniformity correction data 610a for correcting premeasured bias error of the display screen 128. For example, the DUC 504 may include a bias uniformity correction (BUC) generator 602 (alternatively referred to panel spot correction), and bias compensation data 136a, which compensates for the characteristic shift non-uniformity of the display screen 128. In response the timing signals 132 indicating a current pixel location, the BUC generator 602 retrieves the bias compensation data 136a corresponding to the current pixel location and interpolates the bias compensation data 136a to produce the bias uniformity correction data 610a.

The display uniformity controller (DUC) 504 also may include means for generating gain uniformity correction data 610b for correcting premeasured gain error of a display device. For example, the DUC 504 may include a gain uniformity correction (GUC) generator 604 and gain compensation data 136b, which compensates for display gain non-uniformity. The GUC generator 604 retrieves the gain compensation data 136b corresponding to the current pixel location and interpolates the gain compensation data 136b to produce the gain uniformity correction data 610b.

The display uniformity controller (DUC) 504 may also include means for generating black-level uniformity correction data 610c for correcting premeasured backlight leakage of the display screen 128. For example, the DUC 504 may include a black level correction (BLC) generator 606 and black level compensation data 136c, which compensates black level non-uniformity. The BLC generator 606 retrieves the black level compensation data 136c corresponding to the current pixel location and interpolates the black level compensation data 136c to produce the black level uniformity correction data 610c.

The display uniformity controller (DUC) 504 also preferably includes means for summing the display data 130 with the bias uniformity correction data 610a, the gain uniformity correction data 610b, and the black level uniformity correction data 610c to produce the uniformity corrected display data 138. For example, the display uniformity controller (DUC) 504 may include an adder 608, which is coupled to the BUC generator 602, the GUC generator 604, and the BLC generator 606, for performing the summation. The uniformity corrected display data 138 may be considered as a complement of the non-uniformity pattern. Overlaying display data 130 with the uniformity correction data 610 to produce the uniformity corrected display data 138 significantly reduces the non-uniformity characteristics of the display screen.

In one embodiment, the BUC generator 602, the GUC generator 604, and the BLC generator 606 are implemented as hardware components. However, the BUC generator 602, the GUC generator 604, and the BLC generator 606 may be implemented as software components, or a combination of hardware and software. Although the BUC generator 602, the GUC generator 604, and the BLC generator 606 are shown as separate components, the functionality of each may be combined into a lesser or greater number of components. Also, in one embodiment, the different types of compensation data, collectively referred to as compensation data 136 in FIG. 5, are stored in respective memories that may reside in the respective generators 602, 604, and 606, in the DUC 504 in general, or elsewhere in the display device 100. Alternatively, the different types of compensation data 136 may be stored in a single memory.

FIG. 6B shows the components of the DUC 504 in further detail, where like components of FIG. 6A share like reference numerals. FIG. 6B shows that the DUC 504 includes one common BUC generator 602, and three GUC generators 604a, 604b, and 604c, and three BLC generators 606a, 606b, and 606c for respective R, G, B colors. The BUC generator 602 outputs the bias uniformity correction data 610a (FIG. 6A) as gray data that is common for R, G, and B. The GUC generators 604a, 604b, and 604c output R, G, and B independent gain uniformity correction data 610b (FIG. 6A). The BLC generators 606a, 606b, and 606c output R, G, and B independent black-level uniformity correction data 610c (FIG. 6A). The gain compensation data 136b may be stored in a common memory (e.g., SRAM) that is shared by the GUC generators 604a, 604b, and 604c. Likewise, the black level compensation data 136c may be stored in a common memory that is shared by the BLC generators 606a, 606b, and 606c. The DUC 504 may include separate adders 606a, 606b, and 606c for summing the R, G, and B independent uniformity-corrected data 610.

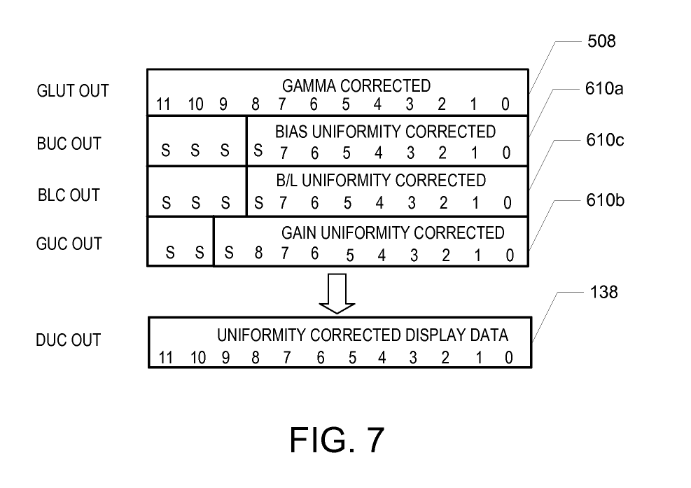

FIG. 7 is a diagram graphically illustrating a bit overlay arrangement used by the DUC 504 to generate the 12-bit uniformity corrected display data 138. As shown, the DUC 504 operates on 12-bit data, and sums the gamma corrected display data 508, the bias uniformity correction data 610a, which includes four sign bits “S”, the black level uniformity correction data 610c, which includes four sign bits, and the gain uniformity correction data 610b, which includes three sign bits, to generate the 12-bit uniformity corrected display data 138.

The details of the operation of bias uniformity correction (BUC) generator 602, the gain uniformity correction (GUC) generator 604, and the black level correction (BLC) generator 606 of FIGS. 6A and 6B will now be described, followed by details of the operation of the gamma lookup table (GLUT) 502 and frame rate controller (FRC) 506 of FIG. 5.

According to the exemplary embodiment, the gain uniformity correction (GUC) generator 604 generates the gain uniformity correction data 610b through an interpolation and a multiplication operation; the bias uniformity correction (BUC) generator 602 generates the bias uniformity correction data 610a through an interpolation and addition/subtraction operation; and the black level correction (BLC) generator 606 generates black level uniformity correction data 610c through an interpolation and a multiplication operation, as described below.

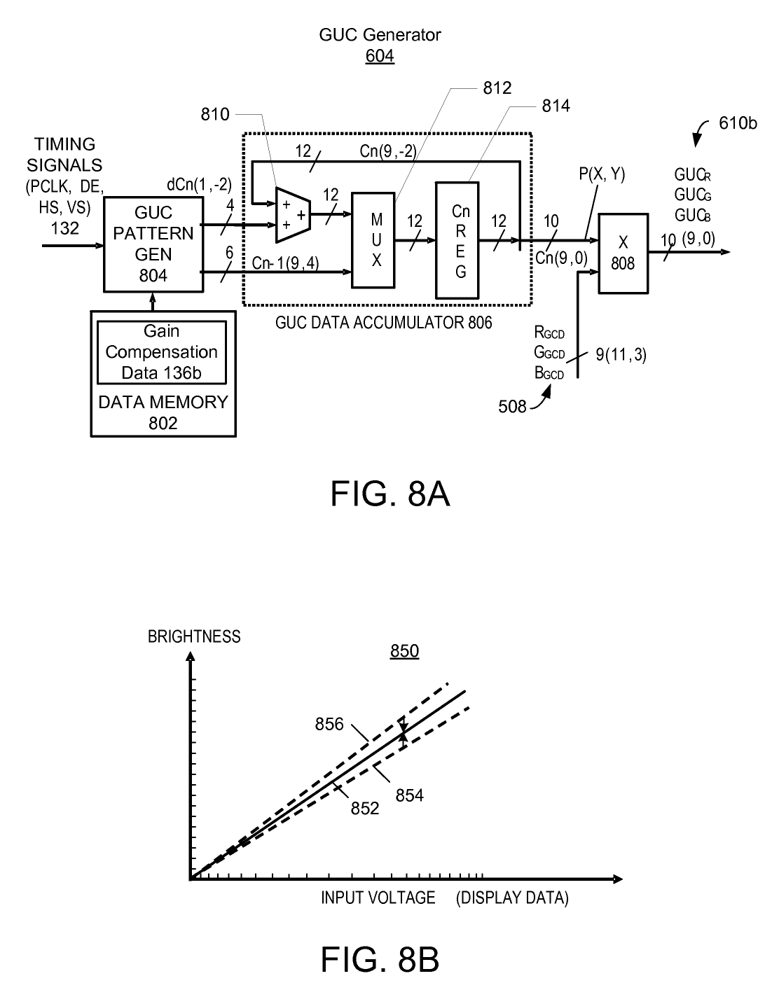

FIG. 8A is a block diagram showing components of the gain uniformity correction (GUC) generator 604. In an exemplary embodiment, the GUC 604 includes a data memory 802, a pattern generator 804, a data accumulator 806, and a multiplier 808. The data accumulator 806 further includes an adder 810, a multiplexer 812, and a data register 814.

Inputs to the pattern generator 804 are the timing signals 132, which include the pixel clock (PCLK) signal, the display enable (DE) bit, the horizontal sync (HS) signal, and the vertical sync (VS) signal. The numbers of horizontal sync (HS) signals, vertical sync (VS) signals, and the pixel clock (PCLK) signal locate a current pixel P (X, Y) position to be rendered. Inputs to the multiplier 808 include the R, G, B independent gamma corrected display data 508 from the GLUT 502.

The GUC 604, which includes separate RGB GUC blocks (as shown in FIG. 6B), generates and outputs R, G, and B gain uniformity correction data 610b for the current pixel P (X, Y) in parallel by interpolating the gain compensation data 136b stored in the data memory 802. According to the exemplary embodiment, the total memory size of the GUC data memory 802 is 4 K Bytes after compression and storage of the gain compensation data 136b in the data memory 802.

FIG. 8B is a graph 850 showing gain compensation in the display device pixels in accordance with the exemplary embodiment. The values for brightness are shown along the Y-axis of the graph 850, and the input voltage values are shown along the X-axis. As describe previously, different pixel locations of the display screen 128 will react differently to the same input voltage, resulting in various gain curves. For example, a particular input voltage will produce an average brightness value along a normal gain curve 852. According the exemplary embodiment, the gain uniformity correction data 610b corrects those pixel locations that appear darker at the same input voltage, as shown by curve 854, or produce brighter locations, as shown by curve 856, such that at that particular input voltage, the points along curves 854 and 856 will be displayed with the same brightness value the point on curve 852.

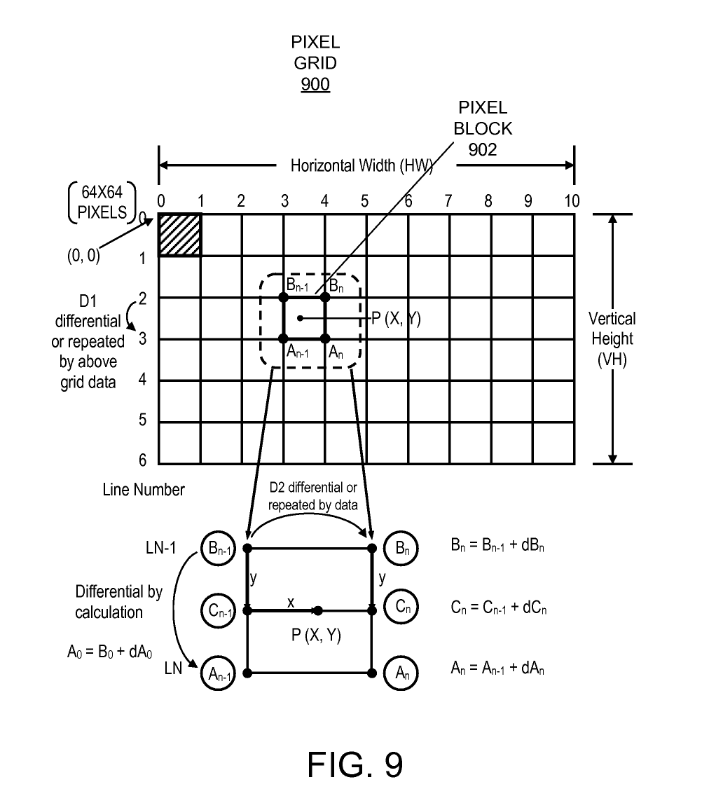

A description of how the gain compensation data 136b shown in FIG. 8A is fetched from the data memory 802 is provided with respect to FIG. 9.

FIG. 9 is a diagram showing the gain compensation data 136b stored as a pixel grid in the data memory 802 of the GUC 604 and interpolation operations for current pixel P (X, Y). As described previously, the pixel grid 900 is created by dividing the display screen 128 by vertical and horizontal lines where intersections of these lines determine grid points and four adjacent grid points the define pixel blocks 902. In the example shown, the size of the blocks 902 in the pixel grid 900 are 64×64 pixels. The number of vertical lines is given by Vertical Height (VH) and horizontal line is given by Horizontal Width (HW). The screen origin (0, 0) is assigned Rs, Gs, and Bs starting data.

Given P (X, Y), the pattern generator 804 reads from the data memory 802 the gain compensation data 136b, which are preferably stored as different values, for the four corners (An, An−1, Bn, and Bn−1) defining the pixel block 902 in which P (X, Y) lies. The actual compensation data 136b to be applied to P (X, Y) is determined by interpolating the gain compensation data 136b of the four surrounding corners (An, An−1, Bn, and Bn−1). The compensation data for the four corners of the block 902 is interpolated in the Y direction first along the column lines of the pixel block 902 (e.g., between points Bn−1 and An−1 to calculate Cn−1 color and between points Bn and An to calculate Cn), followed by interpolation in the X direction along the pixels of the scan line on which the current pixel P (X, Y) lies (e.g., between points Cn and Cn-1).

Linear interpretation between the grid points is achieved by calculating vertical differential values and horizontal differential values (dAn, dBn, and dCn) from the compensation data 136b stored for grid points An, An−1, Bn, and Bn−1. For example, between the points Cn−1 and Cn, the pattern generator 804 calculates the differential value dCn between neighboring pixels of the scan line between the points Cn−1 and Cn. That is, for each pixel of the scan line to be rendered, a delta dCn is calculated between the current pixel and the previous pixel. The pattern generator 804 outputs each dCn value to the data accumulator 806, where the dCn values are accumulated until P(X,Y) is reached along the scan line.

The data accumulator 806 generates an interpolated gain correction data Cn for the current pixel P (X, Y), where Cn=dCn+Cn−1. Thus, the data accumulator 806 iteratively adds the compensation data of the previous pixel to calculate the compensation data for the current pixel. The gain correction data Cn interpolated from the summation of the dCn's is then applied to P (X, Y) by being input to the multiplier 808 for multiplication with the gamma corrected RGB display data 508. In the exemplary embodiment, both the output from the multiplexer 812 and the data register 814 are 12 bits. Based on the above, it can be seen that calculation of the gain compensation data 610b through linear interpolation is performed through a multiplication operation.

This section describes the details of the interpolation process. In operation, before interpolation, initial value Cn−1 is input to the multiplexer 812, then input to the data register 814 for storage. For the next pixel in the scan line, the current correction value Cn is input to the adder 810. The dCn for the current pixel is input to the adder 810, and these are added by the adder 810 prior to being input to the multiplexer 812.

The pattern generator 804 loads Rs, Gs, and Bs data before display screen scan start. In parallel to the screen scan, the pattern generator 804 fetches R, G, and B gain compensation data 136b for the current block from the data memory 802. Referring again to FIG. 9, in an exemplary embodiment, each grid point stores the gain compensation data 136b as 4-bit differential data. D1 shows that when a current block 902 is located on the beginning of a line, the 4-bit gain compensation data 136b provides a vertical differential value from the above grid (Note: The first data of the first line has a zero value for the gain compensation differential value). D2 shows that when a current block 902 is not on the beginning of the line; the 4-bit gain compensation data 136b provides a horizontal differential value from the previous (left) grid point. The 4-bit gain compensation data 136b may be defined as the following:
Value of 7 to 0; indicates 7 to 0 differential values from the previous block.
Value of F_{H} to 9; indicates −1 to −7 differential values from the previous block (minus data use 2's complement format).
Value of 8, indicates repeating data. The previous data is repeated horizontally (differential value=0) and next 4-bit data gives the repeat number. If this second 4-bit=0, it means the data is end of the line.

Referring to FIGS. 8 and 9, if the scan line is the first line, line 0 of the pixel grid 900, e.g., P (X, Y) Y=0, then An=Bn. The pattern generator 804 reads the gain compensation data 136b stored for data dA₀, dA₁, dA₂ to the line end dA_{LAST}. The dAₙ and dBₙ are the same data on the first line. The data memory address for dA₀ is stored into B data start address register. When next line scan starts (Y=n≠0), dA₀ data is read from next address of dA_{LAST} and dB₀ data is read from the B data start address. The dA₁, dB₁ are read from next addresses of dA₀ and dB₀ respectively. Then, interpolation is started in the first left block. It is continued one by one incrementing memory addresses to calculate Aₙ₋₁, Aₙ, Bₙ₋₁, and Bₙ. The pattern generator 804 outputs Cₙ₋₁ (6-bit) and dCₙ (4-bit), which is calculated from Aₙ₋₁, Bₙ₋₁, dAₙ, dBₙ, and y (y=Y mod 64);

where Cₙ₋₁=Aₙ₋₁·(1−y)+Bₙ₋₁·(y) and dCₙ=dAₙ₋₁ ·(1−y)+dBₙ₋₁·(y)

P(X, Y) is accumulated every PCLK by GUC data accumulator 806 and stored in data register 814 and P(X, Y) is given by:

$$P ( X , Y ) = {C}_{n - 1} + {dC}_{n} \cdot ( x ) and x = X mod 64$$

$$because$$

$$\begin{matrix}P ( X , Y ) = {C}_{n - 1} + {dC}_{n} \cdot ( x ) \\ = {C}_{n - 1} + ( {C}_{n} - {C}_{n - 1} ) ( x ) \\ = {C}_{n - 1} \cdot ( 1 - x ) + {C}_{n} \cdot ( x ) \\ = [ {A}_{n - 1} \cdot ( 1 - y ) + {B}_{n - 1} \cdot ( y ) ] \cdot ( 1 - x ) + [ {A}_{n} \cdot ( 1 - y ) + {B}_{n} \cdot ( y ) ] \cdot ( x ) \\ = [ {A}_{n - 1} \cdot ( 1 - y ) \cdot ( 1 - x ) + {B}_{n - 1} \cdot ( y ) \cdot ( 1 - x ) ] + \\ [ {A}_{n} \cdot ( 1 - y ) ( x ) + {B}_{n} \cdot ( y ) ( x ) ] \\ = {A}_{n - 1} \cdot ( 1 - y ) - {A}_{n - 1} \cdot x + {A}_{n - 1} \cdot y \cdot x + {B}_{n - 1} \cdot y - {B}_{n - 1} \cdot yx + \\ {A}_{n} \cdot x - {A}_{n} \cdot yx + {B}_{n} \cdot y \cdot x \\ = [ {A}_{n - 1} \cdot ( 1 - y ) + {B}_{n - 1} \cdot ( y ) ] + [ {A}_{n} - {A}_{n - 1} ) \cdot ( 1 - y ) + \\ ( {B}_{n} - {B}_{n - 1} ) \cdot ( y ) ] \cdot ( x )\end{matrix}$$

$$then$$

$${C}_{n - 1} = {A}_{n - 1} \cdot ( 1 - y ) + {B}_{n - 1} \cdot ( y )$$

$$and$$

$${dC}_{n} = {dA}_{n - 1} \cdot ( 1 - y ) + d {B}_{n - 1} \cdot ( y )$$

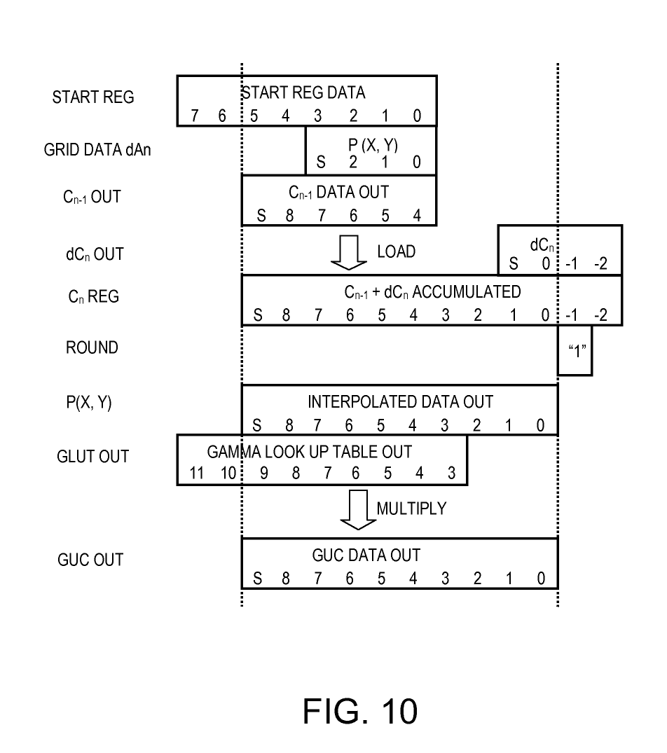

FIG. 10 is a diagram illustrating bit arrangement of the GUC generator 604 internal data bus bit alignment of variables used for generating the gain uniformity correction data 610b according to an exemplary embodiment.

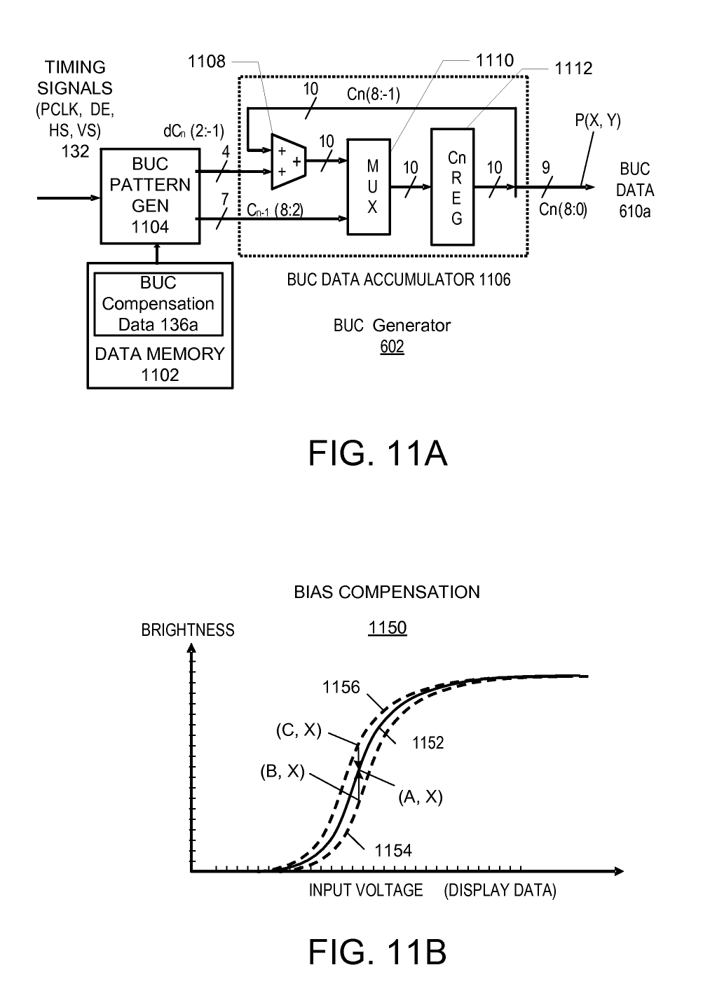

FIG. 11A is a block diagram showing components of the bias uniformity correction (BUC) generator 602. In an exemplary embodiment, the GUC 602 includes a data memory 1102, a pattern generator 1104, and a data accumulator 1106. The data accumulator 1106 further includes an adder 1108, a multiplexer 1110, and a data register 1112. Inputs to the pattern generator 1404 are the timing signals 132 and the bias compensation data 136a stored in the data memory 1102. The BUC 602 includes most of the same components and operates similar to the GUC 604. The only difference is that correction is an addition/subtraction operation. Therefore, the BUC 602 does not include a multiplier for applying the bias corrected data Cn to the RGB data. Instead, the output of the BUC 602 is the bias uniformity correction data 610a for the current pixel P (X, Y).

FIG. 11B is a graph 1150 showing bias compensation in the display device pixels in accordance with the exemplary embodiment. The values for brightness are shown along the Y-axis of the graph 1150, and input voltage values are shown along the X-axis. As described previously, different pixel locations of the display screen 128 will react differently to the same input voltage due to various variables, such as temperature, dust, and production process parameters, which will vary characteristics of the display screen 128, resulting in bias response curves that very from normal. For example, a particular input voltage will produce an average/normal brightness value, at pixel (A, X), along a normal bias response curve 1152. According the exemplary embodiment, the bias uniformity correction data 610a corrects those pixel locations may appear darker at the same input voltage, as shown by point (B, X) on bias response curve 1154, or brighter, as shown by point (C, X) on bias response curve 1156, such that at that particular input voltage, points (B,X) and (C,X) will be displayed with the same brightness value as point (A, X).

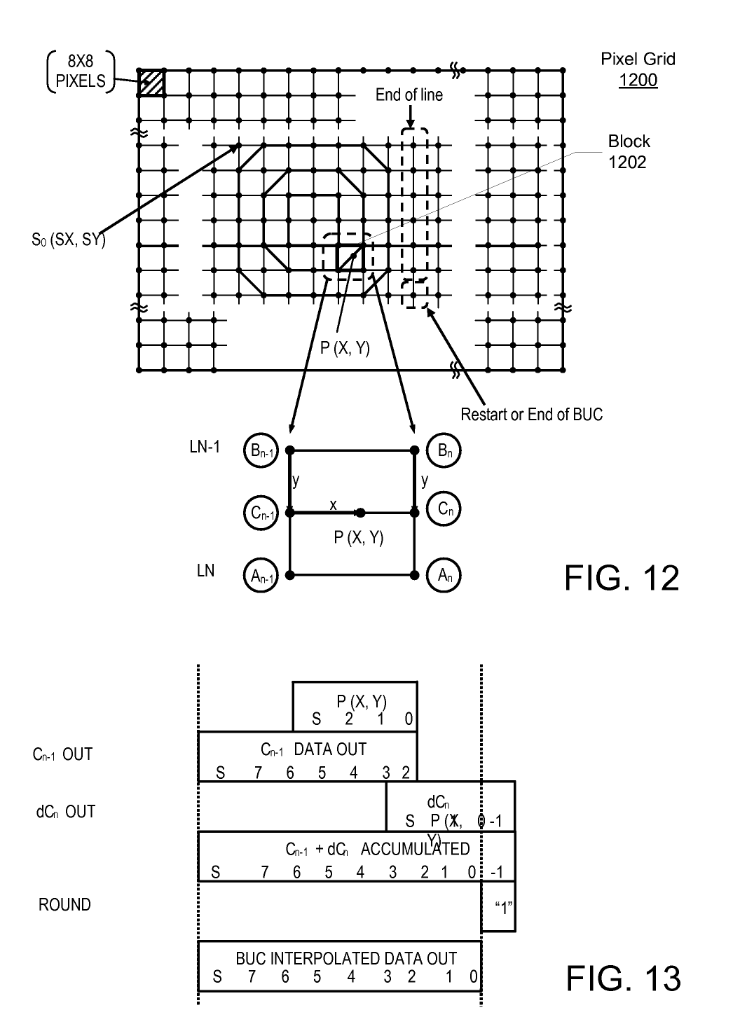

FIG. 12 is a diagram showing the bias compensation data 136a stored as a pixel grid 1200 in the data memory 1102 of the BUC 602 and interpolation operations for current pixel P (X, Y). In an exemplary embodiment, each grid point stores the bias compensation data 136a as 4-bit differential data. One block 1202 of the pixel grid 1200 specifies a single bias compensation data 136a pattern and the block 1202 is configured by several data. Unlike gain, which is applied over a large region of the display screen 128, bias is localized on the display screen 128, and different areas of the display screen 128 may have large or small regions that require bias compensation. Therefore, during the setup stage, the blocks within the pixel grid 1202 may be defined with varying sized blocks 1202, where large blocks 1202 form a hexagonal shape, while smaller blocks 1202 form a square shape, as shown.

The first 2 bytes specify pattern grid start point (PGSP) SX and SY. The bias compensation data 136a value of PGSP starting point is zero. The first 4-bit of a data line provides a delay count of the interpolation start. It is treated as pattern start right shift number. The 4-bit bias compensation data 136a provides a horizontal differential value from the previous (left) grid point. The 4-bit bias compensation data 136a may be defined as the following:
Value of 6 to 0; indicates 6 to 0 differential values from previous block.
Value of F_{H} to A_{H}; indicates −1 to −6 differential values from previous block (minus data use 2's complement format).
Value of 7 indicates short repeat data. The previous data is repeated horizontally (differential value=0) and next 4-bit data gives the repeat number. If this second 4-bit is 0_{H}, it means the end of line.
Value of 8 indicates long repeat data. The previous data is repeated horizontally (differential value=0) and next 8-bit data gives the repeat number.
Value of 9 indicates a repeat line. The previous/above line is repeated vertically and next 4-bit data gives the repeat number.
   If this second 4-bits is 1_{H}, it means one line is repeated and the third 4-bit gives delay count of interpolation start (it is treated as pattern start right shift number).
   If this second 4-bits is 0_{H}, it means the end of bias compensation data 136a data.
   If this second 4-bits is F_{H}, it means restart of the bias compensation data 136a data. The following 2 bytes give PGSP of next bias compensation data 136a data block. The bias compensation data 136a data block can repeat any number till data becomes 90_{H}.

Referring to FIGS. 11 and 12, the bias pattern generator 1104 loads the first pattern grid start point (PGSP) S₀ (SX, SY) before screen scan start and waits for the screen scan to reach the start position. In parallel to the screen scan, the pattern generator 1104 fetches the bias compensation data 136a for the common data from the data memory 1102. If the scan line is the first line of bias compensation data 136a pattern, An=Bn, then the pattern generator 1104 reads dA₀ (=0), dA₁, dA₂ to the line end dA_{LAST} (by detecting 70_{H}) and outputs dCₙ₋₁ and dCₙ. The data memory address for dA₀ maybe stored in a B data start address register. When next line scan starts (Y=n+1, SY=n), dA₀ data is read from next address of dA_{LAST} and dB₀ data from the B data start address. The dA₁ and dB₁ values are read from next addresses of dA₀ and dB₀. Then, interpolation is started in the first left block. It is continued one-by-one incrementing memory addresses to calculate Aₙ₋₁, Aₙ, Bₙ₋₁, and Bₙ.

The pattern generator 1104 outputs Cₙ₋₁ (7-bit) and dCn (4-bit), which is calculated value from Aₙ₋₁, Bₙ₋₁, dAₙ, dBₙ, and y (y=Y mod 8):

where Cₙ₋₁=Aₙ₋₁·(1−y)+Bₙ₋₁·(y) and dCₙ=dAₙ₋₁·(1−y)+dBₙ₋₁·(y)

P(X, Y) is accumulated every PCLK by BUC data accumulator 1106 and stored in the data register 1112 and P(X, Y) is given by:

P(X,Y)=Cₙ₋₁+dCₙ·(x) and x=X mod 8

For each pixel of the scan line to be rendered, the delta dCn is calculated between the current pixel and the previous pixel. The pattern generator 1104 outputs each dCn value to the data accumulator 1106, where the dCn values are accumulated until P(X,Y) along the scan line is reached. The data accumulator 1106 generates an interpolated bias correction data Cn for the current pixel P (X, Y), where Cn=dCn+Cn−1. Thus, the data accumulator 1106 iteratively adds the compensation data of the previous pixel to calculate the compensation data for the current pixel. The bias correction data Cn interpolated from the summation of the dCn's by the data register 1112 is then output as the bias uniformity correction data 610a and applied to P (X, Y). In the exemplary embodiment, the output from the BUC 602 is 9 bits.

Based on the equations, it can be seen that calculation of the bias compensation data 610a through linear interpolation is performed using only addition and subtraction.

FIG. 13 is a diagram illustrating bit arrangement of the BUC generator 602 internal data bus bit alignment of variables used for generating the bias uniformity correction data 610a according to an exemplary embodiment.

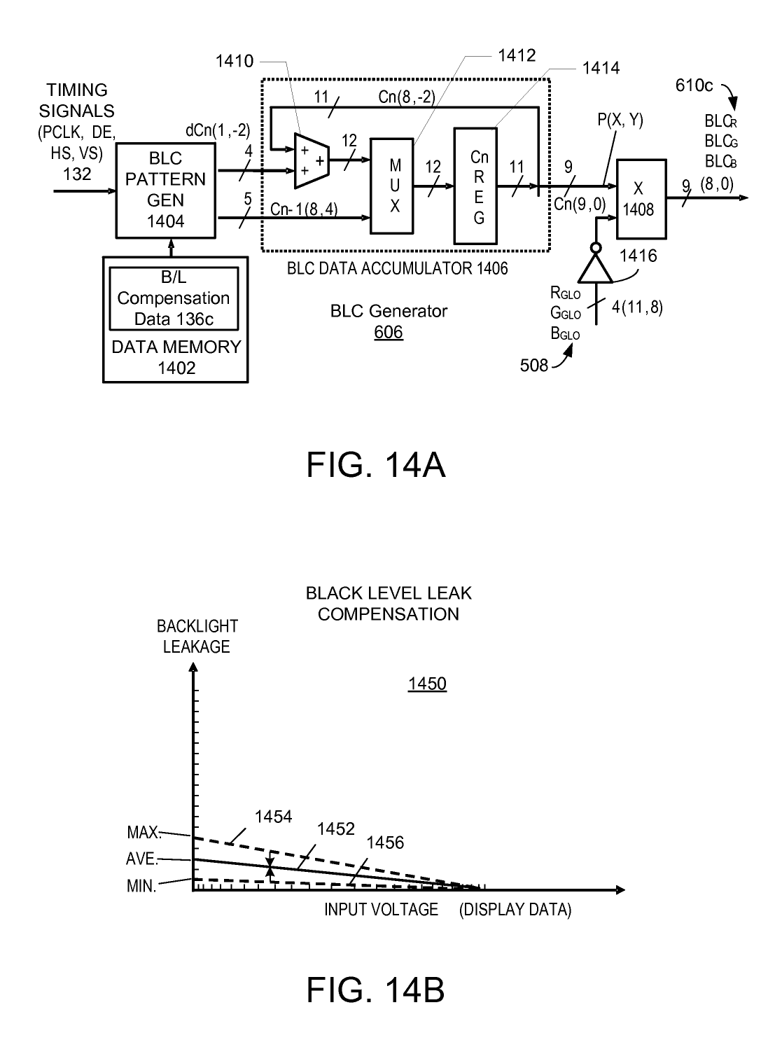

FIG. 14A is a block diagram showing components of the black level uniformity correction (BLC) generator 606. In an exemplary embodiment, the BLC generator 606 includes a data memory 1402, a pattern generator 1404, a data accumulator 1406, and a multiplier 1408. The data accumulator 1406 further includes an adder 1410, a multiplexer 1412, and a data register 1414. Inputs to the pattern generator 1404 are the timing signals 132 and the black-level compensation data 136c stored in the data memory 1402. Black level correction is opposite of gain correction. Gain uniformity multiplies gain uniformity correction data 610b with the gamma corrected display data 508, whereas black-level uniformity correction multiplies black-level corrected data Cn with the complement of the gamma corrected display data 508. As shown in FIG. 14, an inverter 1416 may be used to invert the input RGB gamma corrected display data 508 prior to it being input to the multiplier 1408 with the black-level corrected data Cn. The output of the BLC generator 606 is the black-level uniformity correction data 610c for the current pixel P (X, Y).

The BLC 606, which includes separate RGB BLC blocks (as shown in FIG. 6B), generates and outputs R, G, and B black-level uniformity correction data 610c for the current pixel P (X, Y) in parallel by interpolating the black-level compensation data 136c stored in the data memory 1402. According to the exemplary embodiment, the total memory size of the BLC data memory 1402 is 4 K Bytes after compression and stored in the data memory 1402.

FIG. 14B is a graph showing black level leakage correction of the display device pixels in accordance with the exemplary embodiment. The values for brightness correction are shown along the Y-axis of the graph 1450, and input voltage values are shown along the X-axis. At zero input voltage, the pixels of the display screen 128 should theoretically be all black. However, the display screen 128, which is responsible for blocking the backlight source 120, is not 100% efficient showing black level, allowing some of the backlight to leak through the pixels resulting in black level variations across the display screen 128. The amount of backlight correction can decrease linearly as the input voltage increases. An example of an average amount of backlight leakage is shown by average curve 1452. According the exemplary embodiment, the black-level uniformity correction data 610c corrects those pixel locations that have greater than average backlight leakage, shown by maximum curve 1454 and those that have less than average backlight leakage, shown by minimum curve 1456, such that at that particular input voltage, the points along curves 1454 and 1456 will be have the same backlight leakage value as the point on curve 1452.

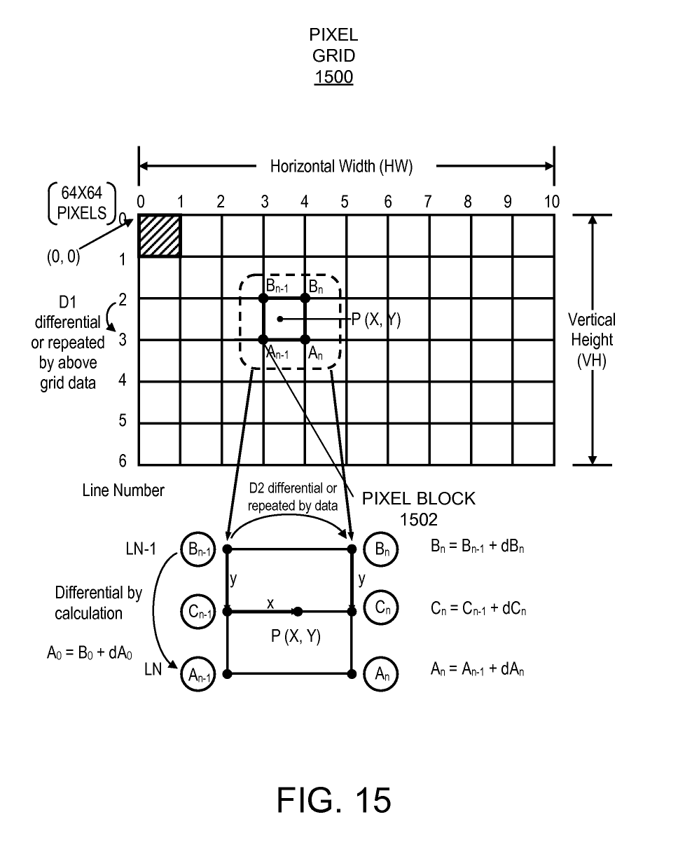

A description of how the black-level compensation data 136c is fetched from the data memory 1402 is provided in conjunction with FIG. 15.

FIG. 15 is a diagram showing the black-level compensation data 136c stored as a pixel grid 1500 in the data memory 1402 of the BLC 606 and interpolation operations for current pixel P (X, Y). As described previously, the pixel grid 1500 is created by dividing the display screen 128 by vertical and horizontal lines where intersections of these lines determine grid points and four adjacent grid points the define blocks 1502. In the example shown, the size of the blocks 1502 in the pixel grid 1500 are 64×64 pixels. The number of vertical lines is given by Vertical Height (VH) and horizontal line is given by Horizontal Width (HW). The screen origin (0, 0) is assigned Rs, Gs, and Bs starting data. The required memory size for 1920×1080 pixel resolutions is:

[(1920/64)+1]×[(1080/64)+1]×3/2=31×18×1.5=837 Bytes

Given P (X, Y), the pattern generator 1404 reads from the data memory 1402 the black-level compensation data 136c for the four corners (An, An−1, Bn, and Bn−1) defining the pixel block 1502 in which P (X, Y) lies. The actual compensation data 136c to be applied to P (X, Y) is determined by interpolating the black-level compensation data 136c of the four surrounding corners (An, An−1, Bn, and Bn−1). The compensation data for the four corners of the block 1502 is interpolated in the Y direction first along the column lines of the pixel block 1502 (e.g., between points Bn−1 and An−1), followed by interpolation in the X direction along the pixels of the scan line on which the current pixel P (X, Y) lies (e.g., between points Bn and Bn−1, and Cn and Cn−1).

Linear interpretation between the grid points is achieved by calculating vertical differential values and horizontal differential values (dAn, dBn, and dCn) from the compensation data 136c stored for grid points An, An−1, Bn, and Bn−1. For each pixel of the scan line to be rendered, a delta dCn is calculated between the current pixel and the previous pixel. The pattern generator 1404 outputs each dCn value to the data accumulator 1406, where the dCn values are accumulated until P(X,Y) along the scan line is reached. The data accumulator 1406 generates an interpolated black-level correction data Cn for the current pixel P (X, Y), where Cn=dCn+Cn−1. Thus, the data accumulator 1406 iteratively adds the compensation data of the previous pixel to calculate the compensation data for the current pixel. The black-level correction data Cn interpolated from the summation of the dCn's is then applied to P (X, Y) by being input to the multiplier 1408 for multiplication with the complement value of gamma corrected RGB display data 508. In the exemplary embodiment, both the output from the data register 1414 and the multiplier 1408 are 9 bits. Based on the above, it can be seen that calculation of the black-level compensation data 610b through linear interpolation is performed through a multiplication operation.

This section describes the details of the interpolation process. In operation, before interpolation, initial values Cn−b 1 are input to the multiplexer 1412, then input to the data register 1414 for storage. For the next pixel in the scan line, the correction value Cn is input to the adder 1410. The Cn−1 for the current pixel is input to the multiplexer 1412, and the dCn is added to the Cn−1 of the previous pixel by the adder 1410 prior to being input to the multiplexer 1412.

The pattern generator 1404 loads Rs, Gs, and Bs data before display screen scan start. In parallel to the screen scan, the pattern generator 1404 fetches R, G, and B black level compensation data 136c for the current block from the data memory 1402. In an exemplary embodiment, each grid point stores the black-level compensation data 136c as 4-bit differential data. D1 shows that when a current block 1502 is located on the beginning of a line, the 4-bit black-level compensation data 136c provides a vertical differential value from the above grid (Note: The first data of the first line is zero). D2 shows that when a current block 1502 is not on the beginning of the line; the 4-bit black-level compensation data 136c provides a horizontal differential value from the previous (left) grid point. The 4-bit black-level compensation data 136c may be defined as the following:
Value of 7 to 0; indicates 7 to 0 differential values from the previous block.
Value of F_{H} to 9; indicates −1 to −7 differential values from the previous block (minus data use 2's complement format).
Value of 8, indicates repeating data. The previous data is repeated horizontally (differential value=0) and next 4-bit data gives the repeat number. If this second 4-bit=0, it means the data is end of the line.

Referring to FIGS. 14A and 15, if the scan line is the first line, line 0 of the pixel grid 1500, e.g., P (X, Y) Y=0, then An=Bn. The pattern generator 1404 reads the black-level compensation data 136c stored for data dA₀, dA₁, dA₂ to the line end dA_{LAST}. The dAₙ and dBₙ are the same data on the first line. The data memory address for dA₀ is stored into B data start address register. When next line scan starts (Y=n≠0), dA₀ data is read from next address of dA_{LAST} and dB₀ data is read from the B data start address. The dA₁, dB₁ are read from next addresses of dA₀ and dB₀ respectively. Then, interpolation is started in the first left block. It is continued one by one incrementing memory addresses to calculate Aₙ₋₁, Aₙ, Bₙ₋₁, and Bₙ. The pattern generator 1404 outputs Cₙ₋₁ (5-bit) and dCn (4-bit), which is calculated from Aₙ₋₁, Bₙ₋₁, dAₙ, dBₙ, and y (y=Y mod 64);

where Cₙ₋₁=Aₙ₋₁·(1−y)+Bₙ₋₁·(y) and dCₙ=dAₙ₋₁·(1−y)+dBₙ₋₁·(y)

P(X, Y) is accumulated every PCLK by BLC accumulator 1406 and P(X, Y) is given by:

$$P ( X , Y ) = {C}_{n - 1} + {dC}_{n} \cdot ( x ) and x = X mod 64$$

$$because$$

$$\begin{matrix}P ( X , Y ) = {C}_{n - 1} + {dC}_{n} \cdot ( x ) \\ = {C}_{n - 1} + ( {C}_{n} - {C}_{n - 1} ) ( x ) \\ = {C}_{n - 1} \cdot ( 1 - x ) + {C}_{n} \cdot ( x ) \\ = [ {A}_{n - 1} \cdot ( 1 - y ) + {B}_{n - 1} \cdot ( y ) ] \cdot ( 1 - x ) + [ {A}_{n} \cdot ( 1 - y ) + {B}_{n} \cdot ( y ) ] \cdot ( x ) \\ = [ {A}_{n - 1} \cdot ( 1 - y ) \cdot ( 1 - x ) + {B}_{n - 1} \cdot ( y ) \cdot ( 1 - x ) ] + \\ [ {A}_{n} \cdot ( 1 - y ) ( x ) + {B}_{n} \cdot ( y ) ( x ) ] \\ = {A}_{n - 1} \cdot ( 1 - y ) - {A}_{n - 1} \cdot x + {A}_{n - 1} \cdot y \cdot x + {B}_{n - 1} \cdot y - {B}_{n - 1} \cdot yx + \\ {A}_{n} \cdot x - {A}_{n} \cdot yx + {B}_{n} \cdot y \cdot x \\ = [ {A}_{n - 1} \cdot ( 1 - y ) + {B}_{n - 1} \cdot ( y ) ] + [ {A}_{n} - {A}_{n - 1} ) \cdot ( 1 - y ) + \\ ( {B}_{n} - {B}_{n - 1} ) \cdot ( y ) ] \cdot ( x )\end{matrix}$$

$$then$$

$${C}_{n - 1} = {A}_{n - 1} \cdot ( 1 - y ) + {B}_{n - 1} \cdot ( y )$$

$$and$$

$${dC}_{n} = {dA}_{n - 1} \cdot ( 1 - y ) + d {B}_{n - 1} \cdot ( y )$$

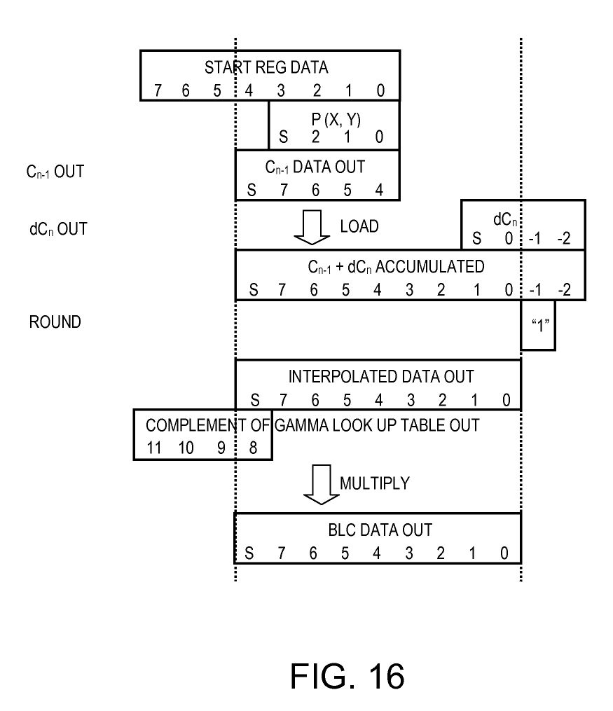

FIG. 16 is a diagram illustrating bit arrangement of the BLC generator 606 internal data bus bit alignment of variables used for generating the black level uniformity correction data 610c according to an exemplary embodiment.

The following section describes the operation of the gamma lookup table (GLUT) 502 shown in FIG. 5.

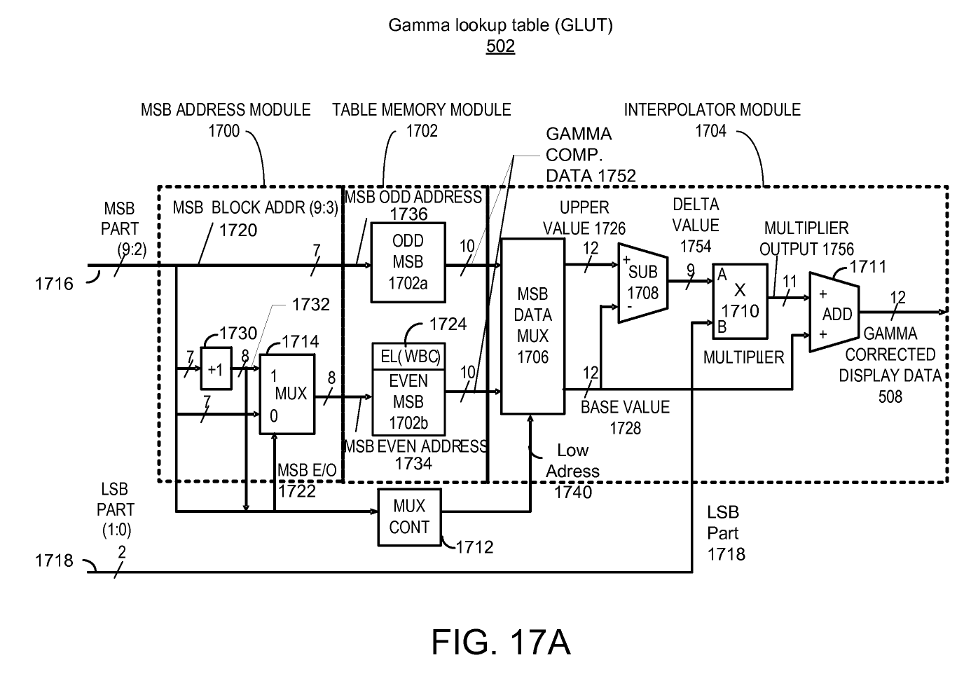

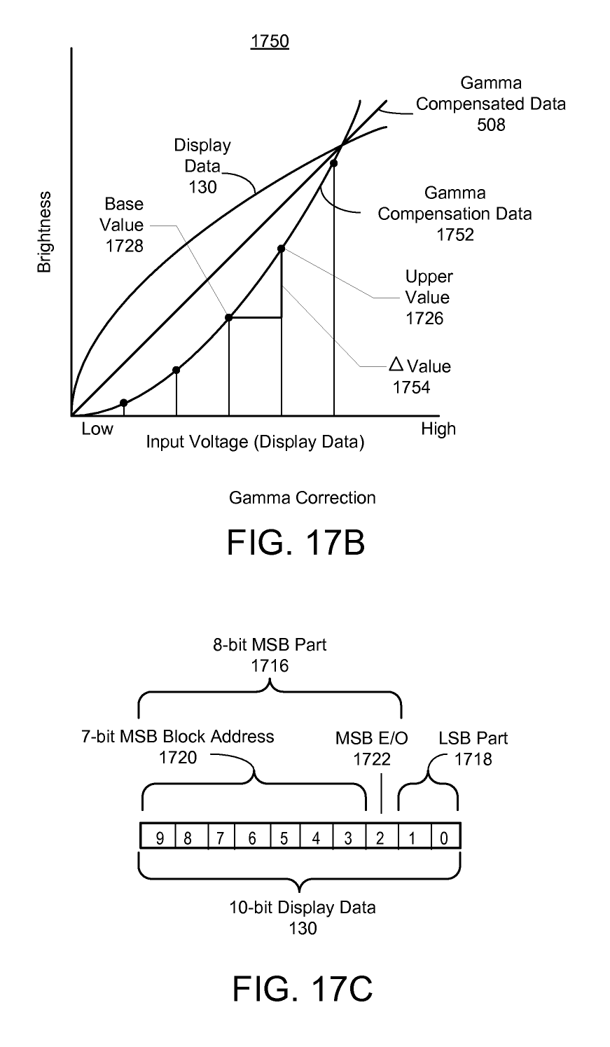

FIG. 17A is a block diagram illustrating components of the gamma lookup table (GLUT) 502, which may be implemented in hardware and/or software. The GLUT 502 includes a most significant bit (MSB) address module 1700, a table memory module 1702, and an interpolator module 1704. As is well-known in the art, gamma correction is an internal adjustment made in the rendering of images or frames. The adjustment causes the spacing of steps of shade between the brightest and dimmest part of an image to appear linear. Most imaging systems have nonlinear signal-to-light-intensity or intensity-to-signal characteristics, meaning that the input voltage of the display data 130 may not be directly proportional to the intensity (power) of light in the scene, and the light emitted by the backlight source 120 of the display screen 128 may not be directly proportional to its input voltage, and so on. Gamma correction is the application of a series of values to the input voltage to compensate for these nonlinear characteristics. Nonlinear devices have a transfer function that is approximated by a single type of mathematical function called a power function that has the general equation;

output=input**gamma

where gamma is an exponent of the power function. By convention, “input” and “output” may be both scaled to the range 0 . . . 1, with 0 representing black and 1 representing maximum white (or red, etc). Normalized in this way, the power function may be described by a single number, the exponent “gamma”.

To display the display data 130 correctly, the intensity on the display screen 128 needs to be directly proportional to the sample values. This is done with a lookup table (often called a LUT) that is loaded with a mapping that implements a power function with gamma values, thus providing “gamma correction” for the gamma encoded in the display data and/or the gamma inherent in the display screen 128. The LUT in FIG. 17A is implemented using as the table memory module 1702.

FIG. 17B is a graph illustrating an example of gamma correction that may occur in the display device 128. The values for brightness are shown along the Y-axis of the graph 1750, and input voltage values (display data) are shown along the X-axis. The display screen 128 operates with varying input voltages, which is a value converted from the display data 130 by the source driver 112. As the input voltage is increased, the brightness of the display screen 128 is increased. However, some types of display data 130, such as broadcast video, have been altered to emphasize the brightness to reduce noise during transmission. As shown by the graph, typically, this alteration occurs on the darker or lower part of the display data 130, which is the part that tends to have more noise compared to the brighter or upper part of the display data. The gamma compensation data 1752 is designed to reduce the overemphasized brightness levels of the display data 130 to produce linear-sample data, i.e., gamma compensated data 508.

Referring to both FIGS. 17A and 17B, the gamma compensation data 1752 is stored as a series of gamma values in the table memory module 1702. According to a further aspect of the exemplary embodiment, the size of the table memory module 1702 in the GLUT 502 is reduced by compressing the gamma compensation data 1752 during the configuration stage, and using interpolation during operation of the display device 100 to decompress the gamma compensation data 1752. The lookup table is one dimensional—it only stores gamma values. For one dimensional interpolation, interpolation is performed by calculating a delta value 1754 between two points, a base value 1728 and an upper value 1726. This contrasts with two-dimensional interpolation (e.g., x-axis and y-axis data), which requires four points to perform interpolation.

Where gamma changes smoothly across the display screen 128, a 12-bit output is needed from the GLUT 502 to provide adequate conversion. With any less than that, sometimes contour bands or Mach bands may appear in the darker areas of the image, where two adjacent sample values are still far enough apart in intensity for the difference to be visible. Conventional gamma lookup tables do not utilize an interpolator module 1704. Instead, all gamma values would need to be stored as a 12-bit value, which would require a 4K memory.

According to the exemplary embodiment, although the received display data 130 is 10 bits, the display data used to access the table memory module 1702 is reduced to 8-bits so that only 256 addresses are required in the table memory module 1702, but each address is capable of storing 10-bit gamma compensation data 508. During operation of the display device 100, the interpolator module 1704 converts the 10-bit data gamma compensation data 1752 into 12 bit data for each of red, green, and blue to produce more precise correction in intensity, while saving storage space. Accordingly, the GLUT 502 is capable of receiving input display data 130 having a first bit length (e.g., 10 bits), uses only a subset of the display data 130 (e.g., 8-bits) as an index to the table memory 1702 to reduce the size of the table memory 1702, and performs interpolation on the gamma compensation data 1752 retrieved from the table memory 1702 to produce gamma corrected display data 508 having a larger bit length (e.g., 12-bits) than the input display data 130.

According to a further aspect of the exemplary embodiment, the GLUT table memory module 1702 is configured as two memories, an odd MSB address memory 1702a for storing odd most significant bit addresses, and an even MSB address memory 1702b for storing even most significant bit addresses. The odd and even MSB address memories 1702a and 1702b are capable of 8-bit address input and may include 128 addresses and 10-bit gamma compensation data 1752 for RGB each. As the names imply, gamma compensation data 1752 having odd addresses are stored in the odd MSB 1702a, and the gamma compensation data 1752 having even addresses is stored in the even MSB 1702b. In this embodiment, the total size of the table memory module 1702 is 960 bytes (3 (RGB)×2 (modules)×128 (addresses)×10 bits).

When a display data 130 address is received, a portion of the display data 130 is used to access the table memory model 1702, and the odd and even MSB address memories 1702a and 1702b are read in parallel to retrieve a first gamma compensation data 1752 value stored at an odd address and a second gamma compensation data 1752 value stored at an even address. According to this aspect of the exemplary embodiment, splitting the table memory and module 1702 into two increases the speed of the memory reads to keep better pace with the speed of the display data 130. In this embodiment, the gamma compensation data 1752 values can be read from the table memory module 1702 at the same pixel clock speed for real time interpolation. Although in an alternative embodiment, the table memory module 1702 could be implemented as a single memory, two serial memory reads would be required to obtain the gamma compensation data 1752 values stored at odd and even addresses, respectively, which would result in decreased performance. Otherwise, the table memory would need to be read at a rate two times faster than the pixel clock speed.

FIG. 17C is a diagram illustrating bit positions of the 10-bit display data 130 that is input to the GLUT 502. Referring to both FIGS. 17A and 17C, according to the exemplary embodiment, performing parallel reads of the odd and even MSB address memories 1702a and 1702b is achieved by first separating the display data 130 into a most significant bit (MSB) part 1716 and a least significant (LSB) part 1718. According to the exemplary embodiment, the MSB part 1716 comprises most significant bits 9 through 2 of the display data 130 and is therefore 8-bits in length, and the LSB part 1718 comprises bits 0 and 1 the display data 130 and is therefore 2-bits in length. Data from the MSB part 1716 becomes memory addresses for both odd MSB address memory 1702a and even MSB address memory 1702b. More specifically, the MSB address module 1700 further converts the MSB part 1716 into a 7-bit MSB block address 1720 (bits 9:3) and a MSB even/odd (E/O) bit 1722 (bit 2).

The MSB address module 1700 only inputs the 7-bit MSB block address 1720 of the MSB part 1716 directly to the odd MSB 702a. The 7-bit MSB block address 1720 is also input to an adder 1730 and a multiplexer 1714 of the MSB address module. The 1-bit MSB E/O 1722 (bit 2) of the MSB part 1716 is used as input to the multiplexer 1714 and a multiplexer control 1712, which may be located outside of the MSB address module 1700. The output of multiplexer 1714 is an 8-bit address used for accessing the even MSB memory 1702b. As shown, the gamma compensation data 1752 output from both the odd and even address memories 1702a and 1702b is 10 bits in length.

Data addressing of the even MSB 1702b is performed as follows. The adder 1730 adds 1 to the 7-bit MSB block address 1720, and outputs the resulting value as an 8-bit address 1732. This 8-bit address is then input to the multiplexer 1714 along with the original MSB block address 1720 and the MSB E/O bit 1722. The multiplexer 714 then checks the value of the MSB E/O bit 1722 to determine if the address in the MSB part 1716 is odd or even. If the value of the MSB E/O 1722 is one, then the address is odd and the multiplexer 1714 outputs the generated 8-bit address 1732 as an 8-bit MSB even address 1734, which is used to read a gamma compensation value from the even MSB 1702b. If the value of the MSB E/O bit 1722 is zero, then the address is even and the multiplexer outputs the 7-bit MSB block address 1720 as the 8-bit MSB even address 1734, which is used to read a gamma compensation value from the even MSB 1702b. The generated 8-bit address 1732 is discarded in this case. Although only seven bits are required to access the memory, an additional one bit value is added to access the even MSB 1702b because when the last address (i.e., the maximum data address EL 1724), of the MSB part 1716 is received, an additional even address is needed to perform the interpolation, so one bit is added by the adder 1730 to generate an 8-bit even address to access the even MSB 1702b. The even last (EL) data 1724 in the even table memory 1702b may contain white balance control data.

The 10-bit gamma compensation data 1752 values output in parallel from the odd and even address memories 1702a and 1702b are received by the interpolator module 1704. As stated previously, lower address regions of the display data 130 typically contain the most noise and require finer gamma compensation than high address regions of the display data 130. Accordingly, the GLUT 502 of the exemplary embodiment is capable of determining whether the display data 130 comprises a low or high address. Since portions of the display data 130 are used as an index to the table memory 1702 and the table memory 1702 stores gamma compensation data 1752 values from low to high addresses, it can also be determined whether the gamma compensated data 1752 values from the odd and even addresses originated from low address regions or high address regions of the table memory module 1702. In response to detecting that the display data comprises a low address, a right shift is performed on the gamma correction data values, thereby decreasing the values of the gamma correction data prior to performing interpolation on the gamma compensation data values, which originated from the low address regions. Performing a right shift or otherwise decreasing gamma correction data values for low display data addresses results in finer interpolation performed on those gamma compensation data 1752 values from low odd and even addresses.

According to the exemplary embodiment, the interpolator module 1704 comprises a most significant bit data multiplexer 1706, a most significant data subtractor 1708, a multiplier 1710, and an adder 1711. The MSB data multiplexer 1706 converts the 10-bit data from the table memory module 1702 into the 12-bit upper and base values 1726 and 1728, and interpolation is then performed between the upper and base values 1726 and 1728 with input from LSB part 1718 of the input data 130, as described below.

The multiplexer control 1712 controls the MSB data multiplexer 1706. The multiplexer control 712 determines if the display data address is low or high (and therefore, whether the gamma compensated data 1752 values from the odd and even addresses originated from low address regions or high address regions of the table memory module 1702) by examining bits 9:8 of the display data 130. There were four possible value of the contents of bits 9:8. 00, 01, 10, and 11. A low address is detected when bits 9:8 have the value 00.

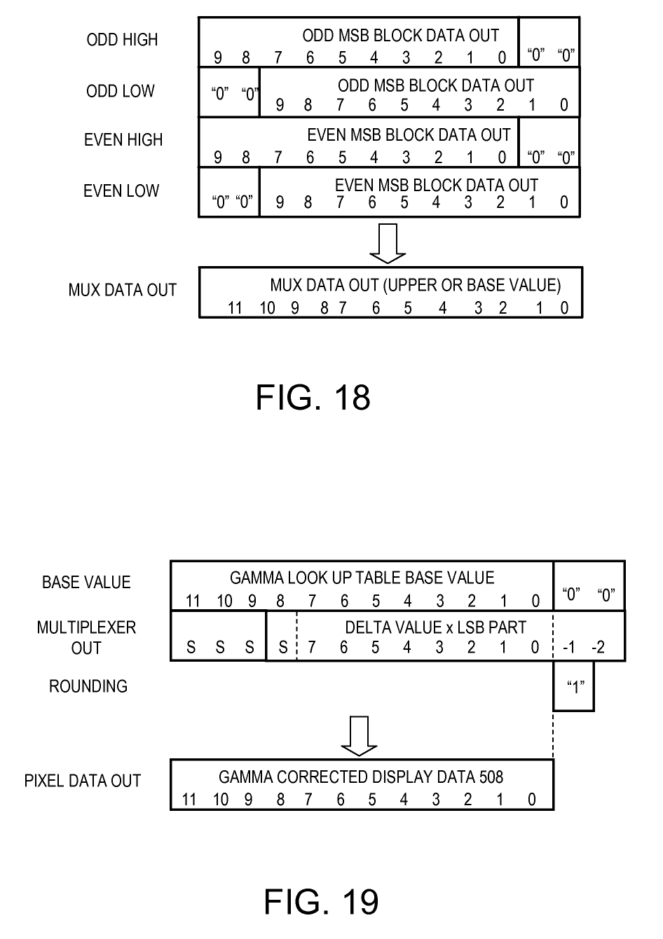

If low address high precision mode is enabled, the multiplexer control 1712 sends a low address signal 1740 to the MSB data multiplexer 1706 when the multiplexer control 1712 detects a low address (e.g., MSB part 1716 bits 9:8=00. In response, the MSB data multiplexer 1706 shifts the gamma compensated data 1752 output of the table memory module 1702 2-bits right, fills bits 9 and 8 with zeros. In the other case where the MSB part 1716 bits (9:8) are not equal to 0 (=High Address), the multiplexer control 712 does not send the low address signal 1740 to the MSB data multiplexer 1706. In absence of the low address signal 1740, the MSB data multiplexer 1706 concatenates two LSB zero bits to the right of the output of the table memory module 1702. The MSB data multiplexer 1706 outputs the 12-bit upper and lower base 1726 and 1728, as shown in FIG. 18. FIG. 18 is a diagram illustrating bit arrangement of MSB data multiplexer 1706 internal data bus bit alignment in accordance with an exemplary embodiment.

After the MSB data multiplexer 1706 outputs the 12-bit upper and base values 1726 and 1728, interpolation between the upper and base values 1726 and 1728 is performed to generate the gamma corrected display data 508 as follows. First, the delta value 1754 is generated by subtracting the base value 1728 from the upper value 1726 using subtracter 1708. Next, the LSB part 1718 is multiplied with the delta value 1754 using multiplier 1710, generating multiplier output 1756. The multiplier output 1756 is then input to an adder 1711 with the base value 1728, the addition of which generates the 12-bit gamma corrected display data 508.

FIG. 19 is a diagram illustrating bit arrangement of the GLUT 502 internal data bus bit alignment of variables used for generating the gamma corrected display data 508 according to an exemplary embodiment. The GLUT data bus bit alignment shown input and output bit positions and relative relation of the interpolator last stage adder 1711 in FIG. 17A.

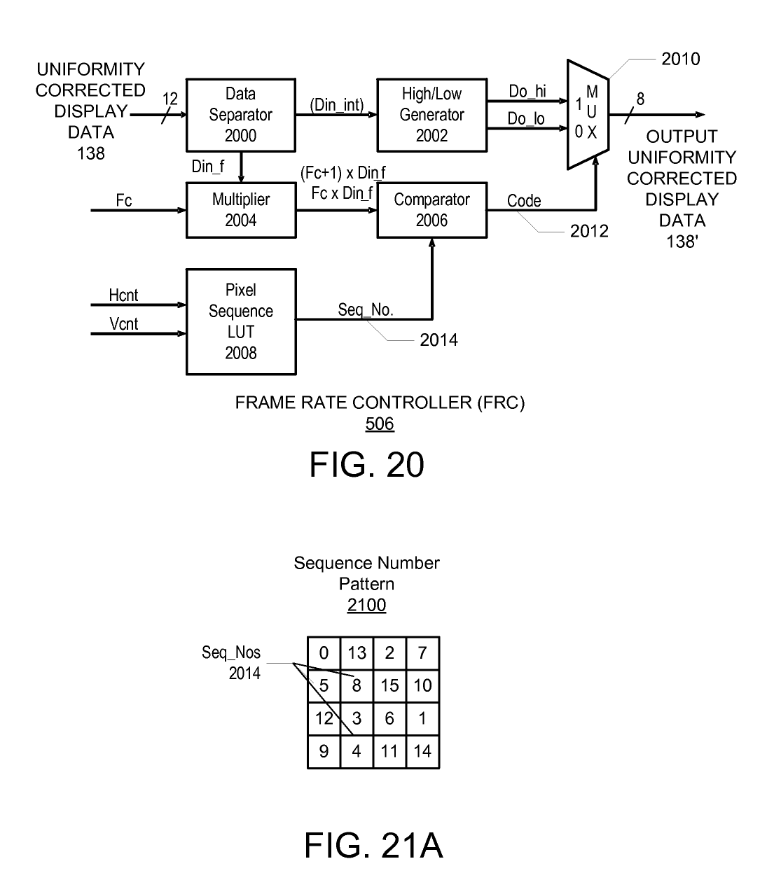

FIG. 20 is a block diagram of the frame rate controller 506 of FIG. 5. One function of the FRC 506 is to overcome certain well-known characteristics of the flat-panel display screen 128. One characteristic is that if various display pixels (picture elements) are excited so that adjacent picture elements are excited in the same phase, undesirable visual artifacts appear, degrading the quality of the resulting image. These artifacts may include visual flickering, and streaming motion. In addition, in certain TFT and STN panels, such as those employing pseudo multiple gray-shade display, roughness in the form of dither patterns can appear on the panel.

In accordance with this aspect of the exemplary embodiment, the FRC 506 compensates for the aforementioned characteristics by performing static and dynamic dithering to provide constant energy both spatially within each frame, and temporally across adjacent frames of the display data. As used herein, the term frame rate control (FRC) refers to the technique of varying the duty cycle at which pixels on the display screen 128 are stimulated in order to generate varying levels of pixel intensity. The result of FRC is commonly referred to as grayscale images but may also refer to color images. FRC can be performed through a variety of levels of limits of pixels on the display screen 128. Sixteen level FRC is described here, but the exemplary embodiment is applicable to other FRC levels.

The frame rate controller (FRC) 506 of the exemplary embodiment preferably includes a data separator 2000, a high/low generator 2002, a multiplier 2004, a comparator 2006, a pixel sequence LUT 2008, and a multiplexer 2010.

The data separator receives the uniformity corrected display data 138. The incoming uniformity corrected display data 138 is 12-bits, meaning that 0 to 4095 shades of gray can be displayed. However, if the display panel data width is 8-bits, the difference between gray levels between two pixels may be much smaller than 256 gray levels, i.e., in the four thousands. Therefore, conventional methods of using input 8- or 10-bit display data fail to provide adequate gray level correction. According to a further aspect of the exemplary embodiment, the bit-width of the output display data, preferably the uniformity corrected display data 138, is increased by increasing frame numbers, e.g., from four to sixteen, to provide for the 12-bit width display data equivalent. The FRC 506 performs a static dither or dynamic dither algorithm on all 12-bits of the uniformity corrected incoming display data 138, and then reduces the data width of the uniformity corrected display data 138 to match the data width of the source driver 112 prior to display by outputting 8-bit dithered uniformity corrected display data 138′.

Referring to FIG. 20, the data separator 2000 separates the received uniformity corrected display data 138 into an integer part comprising the upper bits of the uniformity corrected display data 138, and a fraction part comprising the lower bits of the uniformity corrected display data 138. Preferably, the upper bits of the uniformity corrected display data 138, referred to as Din_int, comprises the upper 8 bits, and the lower bits, referred to as the fraction part, Din_f, comprises the lower 4 bits. Din_int is then input to the High/low generator 2002.

In response to receiving the integer part, Din_int, the High/low generator 2002 generates a data out high value, Do_hi=Din_int+1 (which is a higher energy version of the upper bits of the display data 138), and a data out low value, Do_lo=Din_int. The multiplexer 2010 receives the Do_hi and the Do_lo values and determines which to output as the 8-bit dithered uniformity corrected display data 138′ as follows.

The Multiplier 2004 receives as input the fraction part (Din_f) and an input frame counter value (Fc). The Multiplier 2004 then multiplies the fraction part (Din_f) with the frame counter (Fc), and multiplies the fraction part (Din_f) with the frame counter plus 1 (Fc+1). In one embodiment, the multiplier 2004 outputs the frame count Fc, the multiplied values Fc×Din_f and (Fc+1)×Din_f as ((Fc+1)×Din_f) mod 16, and (Fc×Din_f) mod 16 (or ignore the carry and keep the 4 bits).

The pixel sequence LUT 2008 contains a pattern of sequence numbers (Seq_No.) 2014 and outputs one of the sequence numbers 2014 based on a horizontal pixel counter (Hcnt) and a vertical line counter (Vcnt) values received from the TCON 108.

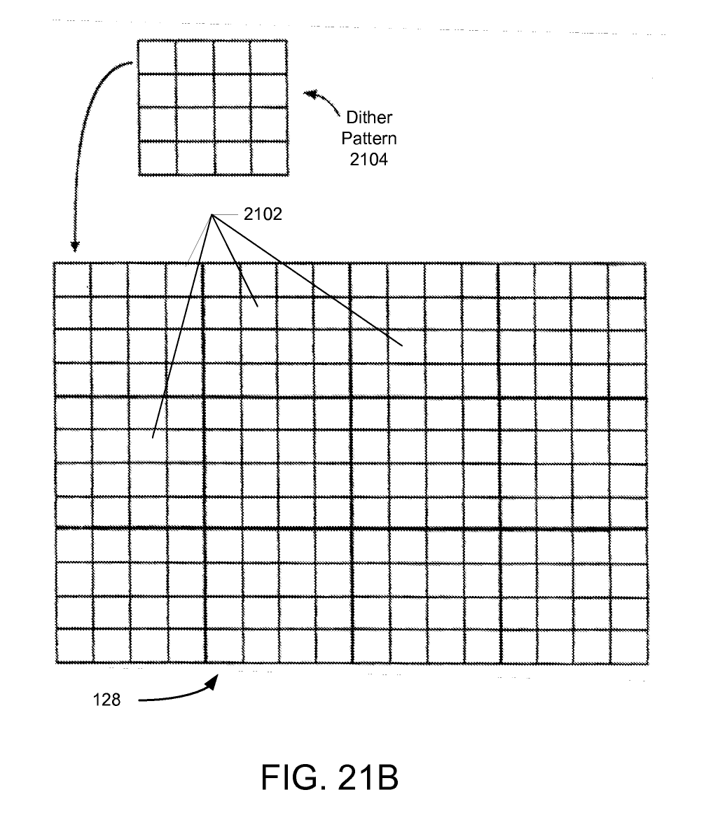

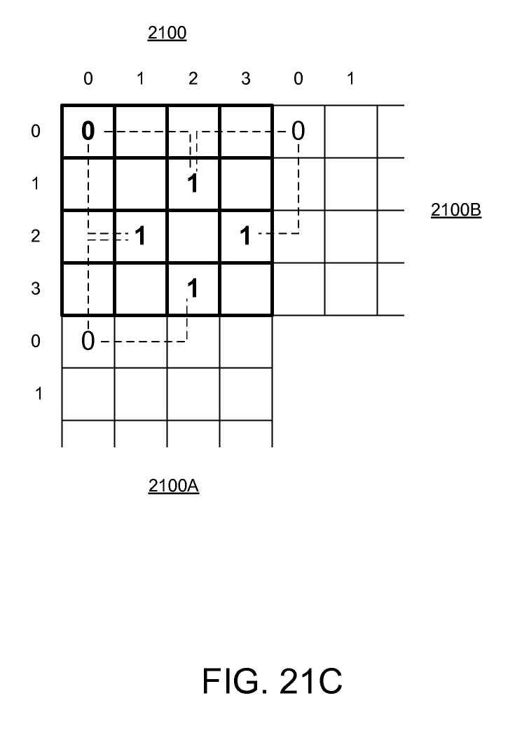

FIG. 21A shows an exemplary sequence number pattern stored in the pixel sequence LUT 2008. The sequence number pattern 2100 comprises a 4×4 matrix having a 2-bit vertical count and a 2-bit horizontal count. The sequence number pattern 2100 includes 16 storage locations for storing 16 sequence numbers, which preferably range in value from 0 to 15.

According to the exemplary embodiment, the sequence numbers 2014 are stored in the sequence number pattern 2100 in a manner that improves distribution of display energy. The sequence numbers 2014 are arranged in the sequence number pattern 2100 such that dither patterns can be derived from the pixel sequence LUT 2008 that evenly distribute energy between the pixels in each frame, and distribute energy between adjacent frames. One key is that the sequence numbers 2014 themselves are evenly distributed within the pattern 2100/LUT 2008. Another key is that the current point and next point (or previous point) have the same distance relation for the dither patterns 2104 between adjacent frames.

FIG. 21B is a diagram showing, by way of an example, the interrelationship between the flat-panel display 128 and a dither pattern 2104. The flat-panel display 128 typically comprises N×M (horizontal×vertical) array of pixels 2102, where N and M may be in the hundreds or thousands. Embodiments described herein perform dithering by applying dither patterns 2104 to the display 128 in adjacent non-overlapping fashion to account for all pixels 2102 on the display 128.

The following is a process for storing sequence numbers 2014 in the LUT 2008 to provide distribution of energy that is spatially and temporally even within the sequence number pattern 2100. The process begins by identifying a starting point for the 4×4 pattern 2100, and storing a first sequence number, e.g., 0, in the starting point of the pattern 2100. In this embodiment, the pattern starting point is the storage location in the upper-left corner of the pattern 2100, at coordinate P (0, 0).

Next, a set of candidate points is generated from the last storage location to determine the storage location of the next sequence number, e.g., 1. The candidate points are generated by moving two positions straight from the last storage location (both vertically and horizontally), then one position to the side (both vertically and horizontally). Another way of stating the same thing is moving one square in any direction then diagonally one position away from its starting position. According to the exemplary embodiment, four candidate points are generated. Only the candidate points falling within the boundary of the 4×4 pattern 2100 are retained, the others are discarded. To generate all possible candidate points within the pattern 2100, the moves are calculated from not only the last storage location within the pattern 2100, but also from storage locations located in symmetrical positions of at least two 4×4 patterns located at coordinates immediately adjacent to the pattern 2100, as shown in FIG. 21C.

FIG. 21C is a diagram illustrating sequence number population of the sequence number pattern 2100. The original pattern 2100 is shown along with patterns 2100A and 2100B. According to the exemplary embodiment, the starting points (shown storing sequence number “0”) are coordinates P (0, 0) in each of the patterns 2100, 2100A, and 2100B. Also shown are four candidate locations, shown by sequence number “1”, generated by moving from the starting points, as described above. The four candidate locations in the pattern 2100 generated from the starting point P (0, 0) have coordinates P (2, 1), P (2, 3), P (1, 2) and P (3, 2).

After the four candidate locations are determined, one of the four open candidate points is randomly chosen as the storage location for the next sequence number. In the example shown in FIG. 21A, location P (3, 2) was chosen as the storage location for sequence number “1”.

Next, four candidate points are determined for the next sequence number, starting from the storage location of the last sequence number using the process above (only empty locations qualify for candidate storage locations). This process is repeated until all sixteen sequence numbers are stored in the pattern 2100. By storing the sequence number 2014 in the LUT 2008 in this manner, the distributed energy is spatially even.

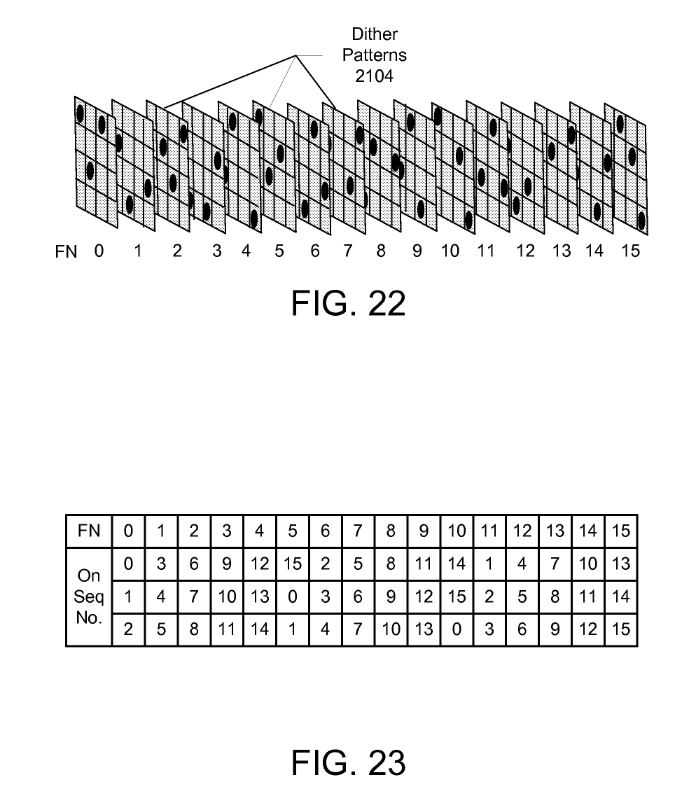

Referring again to FIG. 20, in operation, the 16 storage locations in the pixel sequence LUT 2008 are accessed via 4-bit address. The Hcnt's 2 least significant bits (LSBs) provide the lower 2-bits of this 4-bit address and Vcnt's 2 least significant bits (LSBs) provide the higher 2-bits of this 4-bit address. Based on the values of the Hcnt and the Vcnt for each pixel of display data 138, the pixel sequence LUT 2008 outputs one of the sequence numbers 2014. This sequence numbers 2014 are used to derive sixteen different dither patterns, as shown in FIG. 22.

FIG. 22 shows sixteen dither patterns 2104 that are derived from the sequence number pattern from 2100 such that a constant energy display is created in any 4×4 area in a frame of display data 138, as well as between frames. According to the exemplary embodiment, each dither pattern 2104 is associated with a frame count Fc, numbered from 0 to 15. The frame rate controller 506 may process 60 frames per second, but the dither patterns 2104 shown in FIG. 23 repeat every 16 frames. Each dither pattern 2104 is a 4×4 matrix with each block of the matrix representing a pixel on the display 128. The dither patterns 2104 are applied to the display 128 in a manner described above in conjunction with FIG. 22B. Each dither pattern 2104 is derived by designating which of three sequence numbers 2014 in the sequence number pattern 2100 are active, where black dots indicate the pixels that are stimulated. By only storing the sequence number pattern 2100 in the pixel sequence LUT 2008, sixteen dither patterns 2104 can be derived with minimal storage. By way of example, if Din_f=3 and frame number (Fc) is 3, then Fc×Din_f=3×3=9 and (Fc+1)×Din_f=4×3=12.

FIG. 23 is a table showing the combination of sequence numbers 2014 from the pattern 2100 that are designated as active for each frame count Fc to provide even distribution of temporal energy. The first row is a listing of 16 frame numbers from 0 to 15. The second row list the possible values of the number (Fc×Dint) output by the multiplier 2004, e.g. “0, 3, 6, 9, 12, 15,”, and ignoring carries “2, 5, 8,” and so on. The table shows that for frame number 3, a dither pattern 2104 is generated having active sequence numbers 9, 10 and 11. This is also shown graphically in FIG. 22 by the arrangement of black dots in the dither pattern 2104 associated with frame number 3, which appear over the locations of sequence numbers of 9, 10 and 11 in the pattern 2100 of FIG. 21A.

The comparator 2006 uses the table of FIG. 23 to compare the frame count Fc with the sequence number 2014 output from the pixel sequence lookup table 2008. readable medium containing program instructions, or a combination thereof. Software written according to the present invention is to be either stored in some form of computer-readable medium such as memory or CD-ROM, or is to be transmitted over a network, and is to be executed by a processor. Consequently, a computer-readable medium is intended to include a computer readable signal, which may be, for example, transmitted over a network. Accordingly, many modifications may be made by one of ordinary skill in the art without departing from the spirit and scope of the appended claims. The comparator 2006 compares the Seq_No 2014 with ((Fc+1)×Din_f) mod 16, and (Fc×Din_f) mod 16 (or ignore the carry and keep the 4 bits) that are output of the multiplier 2004 to generate a value (0 or 1) for the Code 2012 as follows:

```
1. If (Fc) × (Din_f) = (Fc + 1) × (Din_f) then Code =0
2. If (Fc) × (Din_f) < (Fc + 1) × (Din_f) then
  If (Fc) × (Din_f) <= Seq_No < (Fc + 1) × (Din_f) then Code =1
  Else Code=0
3. If (Fc + 1) × (Din_f) < (Fc) × (Din_f) then
  If (Fc + 1) × (Din_f) <= Seq_No < (Fc) × (Din_f) then
  Code = 0 else code =1
```

The multiplexer 2010 receives the code 2012 from the comparator 2006 and the Do_hi and Do_low values from the high/low generator 2002. If the output Code 2012 equals 1, then the multiplexer 2010 selects Do_hi to output as the 8-bit dithered uniformity corrected display data 138′. If Code 2012 equals 0, the multiplexer 2010 selects Do_lo to output as the 8-bit dithered uniformity corrected display data 138′.

A method and system for display uniformity correction has been disclosed. The present invention has been described in accordance with the embodiments shown, and one of ordinary skill in the art will readily recognize that there could be variations to the embodiments, and any variations would be within the spirit and scope of the present invention. For example, the embodiments are operable with color spaces other than RGB, such as YUV, CMYK, and YcbCr, for instance, and any transformation thereof. In addition, the embodiments can be implemented using hardware, software, a computer

We claim:

1. A method of correcting non-uniformity of a display device having a display screen comprising a pixel matrix, comprising:
in response to receiving display data for display, reading from a memory of the display device compensation data stored for a subset of pixel locations of the display screen, the compensation data configured to correct non-uniformity characteristics of the display screen;
interpolating the compensation data to generate uniformity correction data;
overlaying the display data with the uniformity correction data to produce uniformity corrected display data; and
outputting the uniformity corrected display data for subsequent display.

2. The method of claim 1 wherein storing of the compensation data is performed during a configuration stage comprising:
measuring non-uniformity characteristics of the display screen;
determining compensation data for correcting the non-uniformity characteristics;
dividing the pixel matrix into a pixel grid of rows and columns, wherein points at row and column intersections of the pixel grid are used to define shapes that encompass multiple pixels;
compressing the compensation data by storing in a memory of the display the compensation data for the points of the pixel grid defining the shapes.

3. The method of claim 2 wherein the compensation data for the points of the pixel grid are stored as differential values, wherein the differential values are differences between the compensation data values between adjacent points.

4. The method of claim 1 wherein the subset of pixel locations define a matrix of shapes across the display screen, wherein at least a portion of the shapes encompass multiple rows and columns of pixel locations on the display.

5. The method of claim 2 wherein in response to receiving a current pixel location from the display data, reading from the memory the compensation data corresponding to the shape encompassing the current pixel location, and interpolating the compensation data to generate uniformity correction data for the current pixel location.

6. The method of claim 4 wherein the matrix of shapes comprises a pixel grid of blocks defined by row and column intersections of the display screen.

7. The method of claim 1 further comprising generating at least one of gain uniformity correction data for correcting premeasured gain error of a display screen, bias uniformity correction data for correcting premeasured bias error of the display screen, and black level uniformity correction data for correcting premeasured backlight leakage of the display screen.

8. The method of claim 7 further comprising summing display data with the gain uniformity correction data, the bias uniformity correction data, and the black level uniformity correction data to produce the uniformity corrected display data.

9. The method of claim 1 wherein a data width of the uniformity corrected display data is wider than a data width of the display data.

10. The method of claim 9 further comprising inputting the display data to a gamma lookup table that outputs gamma corrected data display data that is wider than the data width of the display data, and inputs the gamma corrected data display data to the display uniformity controller.

11. The method of claim 10 further comprising inputting the uniformity corrected display data to a frame rate controller that reduces the data width of the uniformity corrected display data to match the data width of the display data prior to display.

12. A controller for correcting non-uniformity of a display device having a display screen comprising a pixel matrix, comprising:
a memory for storing compensation data, the compensation data stored for a subset of pixel locations of the display screen and configured to correct non-uniformity characteristics of the display screen;
means responsive to receiving display data for reading the compensation data from the memory;
means for interpolating the compensation data to generate uniformity correction data; and
means for overlaying the display data with the uniformity correction data to produce uniformity corrected display data, and for outputting the uniformity corrected display data for subsequent display.

13. A display uniformity controller, comprising:
a gain uniformity correction generator for generating gain uniformity correction data for correcting premeasured gain error of a display screen;
a bias uniformity correction generator for generating bias uniformity correction data for correcting premeasured bias error of the display screen;
a black level correction generator for generating black level uniformity correction data for correcting premeasured backlight leakage of the display screen; and
an adder coupled to the gain uniformity correction generator, the bias uniformity correction generator, and the black level correction generator for summing display data to be displayed on the display screen with the gain uniformity correction data, the bias uniformity correction data, and the black level uniformity correction data to produce uniformity corrected display data.

14. The display uniformity controller of claim 13 wherein a data width of the uniformity corrected display data is wider than a data width of the display data.

15. The display uniformity controller of claim 13 wherein the display data is input to a gamma lookup table, which outputs gamma corrected data display data that is wider than the data width of the display data, and inputs the gamma corrected data display data to the display uniformity controller.

16. The display uniformity controller of claim 15 wherein a frame rate controller is used to reduce the data width of the uniformity corrected display data to match the data width of the display data prior to display.

17. The display uniformity controller of claim 13 wherein the gain uniformity correction generator generates the gain uniformity correction data through a multiplication operation.

18. The display uniformity controller of claim 13 wherein the bias uniformity correction generator generates the bias uniformity correction data through an addition/subtraction operation.

19. The display uniformity controller of claim 13 wherein the black level correction generator generates the black level uniformity correction data through a multiplication operation.

20. The display uniformity controller of claim 13 wherein the uniformity corrected display data is generated through a combination of multiplication and addition/subtraction operations.

21. The display uniformity controller of claim 13 further comprising at least one memory for storing compensation data for a subset of pixel locations on the display screen, the compensation data configured to correct non-uniformity characteristics of the display screen, wherein the gain uniformity correction generator, the bias uniformity correction generator, and the black level correction generator perform interpolation on the compensation data to generate the gain uniformity correction data, the bias uniformity correction data, and the black level uniformity correction data, respectively.

22. The display uniformity controller of claim 21 wherein the compensation data is complementary data to non-uniformities of the display screen.

23. The display uniformity controller of claim 21 wherein the compensation data comprises gray data common to separate red, green, and blue data in the display data.

24. The display uniformity controller of claim 21 wherein the compensation data comprises red, green, and blue data corresponding to red, green, and blue data in the display data, respectively.

25. The display uniformity controller of claim 21 wherein the subset of pixel locations define a matrix of shapes across the display screen, wherein at least a portion of the shapes encompass multiple rows and columns of pixel locations on the display screen.

26. The display uniformity controller of claim 25 wherein the matrix of shapes comprises a pixel grid of blocks defined by row and column intersections of the display screen.

27. The display uniformity controller of claim 25 wherein in response to receiving a current pixel location from the display data, the compensation data corresponding to the shape encompassing the current pixel location is read from the memory and used for the interpolation.

28. The display uniformity controller of claim 21 wherein the memory comprises separate memories including a first memory accessed by the gain uniformity correction generator for storing gain compensation data, a second memory accessed by the bias uniformity correction generator for storing bias compensation data, and a third memory accessed by the black level correction generator for storing black level compensation data.

29. A method of correcting non-uniformity of a display device having a display screen comprising a pixel matrix, comprising:
in response to receiving display data for display, reading from a memory of the display device compensation data stored for a subset of pixel locations of the display screen, the compensation data configured to correct non-uniformity characteristics of the display screen;
overlaying the display data with the compensation data to produce uniformity corrected display data;
performing dithering on the uniformity corrected display data to produce spatial and temporal energy across frames; and
outputting the dithered uniformity corrected display data for subsequent display.

30. The method of claim 29 further comprising interpolating the compensation data to generate uniformity correction data and overlaying the display data with the uniformity correction data to produce the produce uniformity corrected display data.

31. A system for correcting non-uniformity of a display device having a display screen comprising a pixel matrix, comprising:
a memory for storing compensation data, the compensation data stored for a subset of pixel locations of the display screen and configured to correct non-uniformity characteristics of the display screen;
means responsive to receiving display data for reading the compensation data from the memory;
means for overlaying the display data with the uniformity correction data to produce uniformity corrected display data;
means for performing dithering on the uniformity corrected display data to produce spatial and temporal energy across frames; and
means for outputting the dithered uniformity corrected display data for subsequent display.

32. The system of claim 31 further comprising means for interpolating the compensation data to generate the uniformity correction data, and for overlaying the display data with the uniformity correction data to produce the produce uniformity corrected display data.

33. A method of correcting non-uniformity of a display device having a display screen comprising a pixel matrix, comprising:
in response to receiving display data for display, reading from a memory of the display device compensation data stored for a subset of pixel locations of the display screen, the compensation data configured to correct non-uniformity characteristics of the display screen;
generating black level uniformity correction data from the compensation data for correcting premeasured backlight leakage of the display screen;
overlaying the display data with the black level uniformity correction data to produce uniformity corrected display data; and
outputting the uniformity corrected display data for subsequent display.

34. The method of claim 33 further comprising generating black level uniformity correction data by interpolating the compensation data.

35. The method of claim 33 further comprising performing dithering on the uniformity corrected display data to produce spatial and temporal energy across frames; and outputting the dithered uniformity corrected display data for display.

36. A system for correcting non-uniformity of a display device having a display screen comprising a pixel matrix, comprising:
a memory for storing compensation data, the compensation data stored for a subset of pixel locations of the display screen and configured to correct non-uniformity characteristics of the display screen;
means responsive to receiving display data for reading the compensation data from the memory;
means for generating black level uniformity correction data from the compensation data for correcting premeasured backlight leakage of the display screen;
means for overlaying the display data with the black level uniformity correction data to produce uniformity corrected display data;
means for performing dithering on the uniformity corrected display data to produce spatial and temporal energy across frames; and
means for outputting the dithered uniformity corrected display data for subsequent display.

37. A method of correcting non-uniformity of a display device having a display screen, comprising:
measuring non-uniformity characteristics of the display screen, the display screen comprising a pixel matrix;
determining compensation data for correcting the non-uniformity characteristics;
dividing the pixel matrix into a pixel grid of rows and columns, wherein points at row and column intersections of the pixel grid are used to define blocks, each having four grid points, and at least a portion of the blocks encompass multiple pixels;
compressing the compensation data by storing in a memory of the display the compensation data for the points of the pixel grid defining the blocks;
in response to receiving display data for display, reading from the memory the compensation data for the grid points of the block encompassing a current pixel location;
decompressing the compensation data by interpolating the compensation data read from the memory to generate uniformity correction data for the current pixel position;
overlaying the display data with the uniformity correction data to produce uniformity corrected display data; and
outputting the uniformity corrected display data for subsequent display.
